(19) United States
(12) Patent Application Publication
(10) Pub. No.: US 2006/0051802 A1
(43) Pub. Date: Mar. 9, 2006

(54) Artificial receptors, building blocks, and methods

(75) Inventor: Robert E. Carlson, Minnetonka, MN (US)

Correspondence Address: MERCHANT & GOULD PC, P.O. BOX 2903, MINNEAPOLIS, MN, 55402-0903, US

(73) Assignee: RECEPTORS LLC, CHASKA, MN (US)

(21) Appl. No.: 11/223,463

(22) Filed: Sep. 9, 2005

Related U.S. Application Data
(63) Continuation-in-part of application No. 10/244,727, filed on Sep. 16, 2002.
(63) Continuation-in-part of application No. 10/813,568, filed on Mar. 29, 2004.
(63) Continuation-in-part of application No. 10/812,850, filed on Mar. 29, 2004.
Application No. 10/812,850 is a continuation-in-part of application No. 10/813,612, filed on Mar. 29, 2004.
(63) Continuation-in-part of application No. 10/934,977, filed on Sep. 3, 2004.
Application No. 10/934,977 is a continuation-in-part of application No. 10/934,865, filed on Sep. 3, 2004.
Application No. 10/934,865 is a continuation-in-part of application No. 10/934,879, filed on Sep. 3, 2004.
(63) Continuation-in-part of application No. 11/004,593, filed on Dec. 2, 2004.
Application No. 11/004,593 is a continuation-in-part of application No. 10/934,193, filed on Sep. 3, 2004.
(60) Provisional application No. 60/609,160, filed on Sep. 11, 2004.
(60) Provisional application No. 60/612,666, filed on Sep. 23, 2004.
(60) Provisional application No. 60/626,770, filed on Nov. 10, 2004.
(60) Provisional application No. 60/645,582, filed on Jan. 19, 2005.
(60) Provisional application No. 60/649,729, filed on Feb. 3, 2005.

(51) Int. Cl. C40B 40/08; C40B 40/10

(52) U.S. Cl. 435/6; 435/7.1

(57) ABSTRACT

The present invention relates to artificial receptors, arrays or microarrays of artificial receptors or candidate artificial receptors, methods of and compositions for making them, methods of using them, and systems including them. The artificial receptor includes a plurality of building block compounds.

### CROSS REFERENCE TO RELATED APPLICATIONS

The present application is a continuation in part of U.S. patent application Ser. Nos. 10/244,727, filed Sep. 16, 2002, and Ser. No. 10/813,568, filed Mar. 29, 2004, each entitled “ARTIFICIAL RECEPTORS, BUILDING BLOCKS, AND METHODS”; U.S. patent application Ser. Nos. 10/812,850 and 10/813,612, each filed Mar. 29, 2004 and each entitled “ARTIFICIAL RECEPTORS INCLUDING REVERSIBLY IMMOBILIZED BUILDING BLOCKS, THE BUILDING BLOCKS, AND METHODS”; U.S. patent application Ser. No. 10/934,977 entitled “METHODS EMPLOYING COMBINATORIAL ARTIFICIAL RECEPTORS”, Ser. No. 10/934,865 entitled “BUILDING BLOCKS FOR ARTIFICIAL RECEPTORS”, Ser. No. 10/934,879 entitled “NANODEVICES EMPLOYING COMBINATORIAL ARTIFICIAL RECEPTORS”, Ser. No. 10/934,193 entitled “SENSORS EMPLOYING COMBINATORIAL ARTIFICIAL RECEPTORS”, each filed Sep. 3, 2004; U.S. patent application Ser. No. 11/004,593 entitled “ARTIFICIAL RECEPTORS INCLUDING GRADIENTS”, filed Dec. 2, 2004; U.S. patent application Ser. No. ______ entitled “COMBINATORIAL ARTIFICIAL RECEPTORS INCLUDING TETHER BUILDING BLOCKS”, filed Sep. 1, 2005; U.S. patent application Ser. No. ______ entitled “COMBINATORIAL ARTIFICIAL RECEPTORS INCLUDING TETHER BUILDING BLOCKS ON SCAFFOLDS”, filed Sep. 1, 2005; and U.S. patent application Ser. No. ______ entitled SCAFFOLD-BASED ARTIFICIAL RECEPTORS AND METHODS, filed Sep. 1, 2005. The present application claims priority to U.S. Provisional Patent Application Nos. 60/609,160, filed Sep. 11, 2004, 60/612,666, filed Sep. 23, 2004, 60/626,770, filed Nov. 10, 2004, 60/645,582, filed Jan. 19, 2005, and 60,649,729, filed Feb. 3, 2005 and entitled “ARTIFICIAL RECEPTORS, BUILDING BLOCKS, AND METHODS”. Each of these patent applications is incorporated herein by reference in its entirety.

### FIELD OF THE INVENTION

The present invention relates to artificial receptors, arrays or microarrays of artificial receptors or candidate artificial receptors, methods of and compositions for making them, methods of using them, and systems including them. The artificial receptor includes a plurality of building block compounds.

### BACKGROUND

The preparation of artificial receptors that bind ligands like proteins, peptides, carbohydrates, microbes, pollutants, pharmaceuticals, and the like with high sensitivity and specificity is an active area of research. None of the conventional approaches has been particularly successful; achieving only modest sensitivity and specificity mainly due to low binding affinity.

Antibodies, enzymes, and natural receptors generally have binding constants in the 10⁸-10¹² range, which results in both nanomolar sensitivity and targeted specificity. By contrast, conventional artificial receptors typically have binding constants of about 10³ to 10⁵, with the predictable result of millimolar sensitivity and limited specificity.

Several conventional approaches are being pursued in attempts to achieve highly sensitive and specific artificial receptors. These approaches include, for example, affinity isolation, molecular imprinting, and rational and/or combinatorial design and synthesis of synthetic or semi-synthetic receptors.

Such rational or combinatorial approaches have been limited by the relatively small number of receptors which are evaluated and/or by their reliance on a design strategy which focuses on only one building block, the homogeneous design strategy. Common combinatorial approaches form microarrays that include 10,000 or 100,000 distinct spots on a standard microscope slide. However, such conventional methods for combinatorial synthesis provide a single molecule per spot. Employing a single building block in each spot provides only a single possible receptor per spot. Synthesis of thousands of building blocks would be required to make thousands of possible receptors.

Further, these conventional approaches are hampered by the currently limited understanding of the principals which lead to efficient binding and the large number of possible structures for receptors, which makes such an approach problematic.

There remains a need for methods for detecting test ligands in unknown samples and for detecting compounds that disrupt one or more binding interactions.

### SUMMARY

The present invention relates to artificial receptors, arrays or microarrays of artificial receptors or candidate artificial receptors, methods of and compositions for making them, methods of using them, and systems including them. The artificial receptor includes a plurality of building block compounds.

The present invention includes a method of making an array of artificial receptors including building blocks. This method includes forming a plurality of spots on a solid support. At least certain of the spots include a plurality of building blocks. The method includes immobilizing building blocks on the solid support in the spots.

The present invention includes a method of making a receptor surface or an artificial receptor. This method includes forming a region on a support. The region includes a plurality of building blocks. The method includes immobilizing building blocks on the solid support in the region.

The present invention includes methods employing artificial receptors, such as combinatorial artificial receptor arrays. The present receptors include heterogeneous and immobilized combinations of building block molecules. In certain embodiments, combinations of 2, 3, 4, or 5 distinct building block molecules immobilized near one another on a support provide molecular structures that can be employed in the present methods. The present methods can develop artificial receptors that can then be employed to detect the receptor's ligand. The present methods can find compounds that disrupt one or more binding interactions.

The present invention relates to sensors employing artificial receptors, such as combinatorial artificial receptor arrays. The present receptors include heterogeneous and immobilized combinations of building block molecules. In certain embodiments, combinations of 2, 3, 4, or 5 distinct building block molecules immobilized near one another on a support provide molecular structures that can be employed in sensor systems. Sensors employing the present artificial receptors can detect the receptor's ligand.

### BRIEF DESCRIPTION OF THE FIGURES

FIG. 1 schematically illustrates two dimensional representations of an embodiment of a receptor according to the present invention that employs 4 different building blocks to make a ligand binding site.

FIG. 2 schematically illustrates two and three dimensional representations of an embodiment of a molecular configuration of 4 building blocks, each building block including a recognition element, a framework, and a linker coupled to a support (immobilization/anchor).

FIG. 3 schematically illustrates an embodiment of the present methods and artificial receptors employing shuffling and exchanging building blocks.

### DETAILED DESCRIPTION

Definitions

As used herein, the term “peptide” refers to a compound including two or more amino acid residues joined by amide bond(s).

As used herein, the terms “polypeptide” and “protein” refer to a peptide including more than about 20 amino acid residues connected by peptide linkages.

As used herein, the term “proteome” refers to the expression profile of the proteins of an organism, tissue, organ, or cell. The proteome can be specific to a particular status (e.g., development, health, etc.) of the organism, tissue, organ, or cell. The proteome can be a blood plasma proteome.

As used herein, the term “support” refers to a solid support that is, typically, macroscopic.

As used herein, the term scaffold refers to a molecular scale structure to which a plurality of building blocks can covalently bind.

Reversibly immobilizing building blocks on a support couples the building blocks to the support through a mechanism that allows the building blocks to be uncoupled from the support without destroying or unacceptably degrading the building block or the support. That is, immobilization can be reversed without destroying or unacceptably degrading the building block or the support. In an embodiment, immobilization can be reversed with only negligible or ineffective levels of degradation of the building block or the support. Reversible immobilization can employ readily reversible covalent bonding or noncovalent interactions. Suitable noncovalent interactions include interactions between ions, hydrogen bonding, van der Waals interactions, and the like. Readily reversible covalent bonding refers to covalent bonds that can be formed and broken under conditions that do not destroy or unacceptably degrade the building block or the support.

A combination of building blocks immobilized on, for example, a support can be a candidate artificial receptor, a lead artificial receptor, or a working artificial receptor. That is, a heterogeneous-building block spot on a slide or a plurality ofbuilding blocks coated on a tube or well can be a candidate artificial receptor, a lead artificial receptor, or a working artificial receptor. A candidate artificial receptor can become a lead artificial receptor, which can become a working artificial receptor.

As used herein the phrase “candidate artificial receptor” refers to an immobilized combination of building blocks that can be tested to determine whether or not a particular test ligand binds to that combination. In an embodiment, the combination includes one or more reversibly immobilized building blocks. In an embodiment, the candidate artificial receptor can be a heterogeneous building block spot on a slide or a plurality of building blocks coated on a tube or well.

As used herein the phrase “lead artificial receptor” refers to an immobilized combination of building blocks that binds a test ligand at a predetermined concentration of test ligand, for example at 10, 1, 0.1, or 0.01 μg/ml, or at 1, 0.1, or 0.01 ng/ml. In an embodiment, the combination includes one or more reversibly immobilized building blocks. In an embodiment, the lead artificial receptor can be a heterogeneous building block spot on a slide or a plurality of building blocks coated on a tube or well.

As used herein the phrase “working artificial receptor” refers to a combination of building blocks that binds a test ligand with a selectivity and/or sensitivity effective for categorizing or identifying the test ligand. That is, binding to that combination of building blocks describes the test ligand as belonging to a category of test ligands or as being a particular test ligand. A working artificial receptor can, for example, bind the ligand at a concentration of, for example, 100, 10, 1, 0.1, 0.01, or 0.001 ng/ml. In an embodiment, the combination includes one or more reversibly immobilized building blocks. In an embodiment, the working artificial receptor can be a heterogeneous building block spot on a slide or a plurality of building blocks coated on a tube, well, slide, or other support or on a scaffold.

As used herein the phrase “working artificial receptor complex” refers to a plurality of artificial receptors, each a combination of building blocks, that binds a test ligand with a pattern of selectivity and/or sensitivity effective for categorizing or identifying the test ligand. That is, binding to the several receptors of the complex describes the test ligand as belonging to a category of test ligands or as being a particular test ligand. The individual receptors in the complex can each bind the ligand at different concentrations or with different affinities. For example, the individual receptors in the complex each bind the ligand at concentrations of 100, 10, 1, 0.1, 0.01 or 0.001 ng/ml. In an embodiment, the combination includes one or more reversibly immobilized building blocks. In an embodiment, the working artificial receptor complex can be a plurality of heterogeneous building block spots or regions on a slide; a plurality of wells, each coated with a different combination of building blocks; or a plurality of tubes, each coated with a different combination of building blocks.

As used herein, the phrase “significant number of candidate artificial receptors” refers to sufficient candidate artificial receptors to provide an opportunity to find a working artificial receptor, working artificial receptor complex, or lead artificial receptor. As few as about 100 to about 200 candidate artificial receptors can be a significant number for finding working artificial receptor complexes suitable for distinguishing two proteins (e.g., cholera toxin and phycoerythrin). In other embodiments, a significant number of candidate artificial receptors can include about 1,000 candidate artificial receptors, about 10,000 candidate artificial receptors, about 100,000 candidate artificial receptors, or more.

Although not limiting to the present invention, it is believed that the significant number of candidate artificial receptors required to provide an opportunity to find a working artificial receptor may be larger than the significant number required to find a working artificial receptor complex. Although not limiting to the present invention, it is believed that the significant number of candidate artificial receptors required to provide an opportunity to find a lead artificial receptor may be larger than the significant number required to find a working artificial receptor. Although not limiting to the present invention, it is believed that the significant number of candidate artificial receptors required to provide an opportunity to find a working artificial receptor for a test ligand with few features may be more than for a test ligand with many features.

As used herein, the term “building block” refers to a molecular component of an artificial receptor including portions that can be envisioned as or that include one or more linkers, one or more frameworks, and one or more recognition elements. In an embodiment, the building block includes a linker, a framework, and one or more recognition elements. In an embodiment, the linker includes a moiety suitable for reversibly immobilizing the building block, for example, on a suppprt, surface or lawn. The building block interacts with the ligand.

As used herein, the term “linker” refers to a portion of or functional group on a building block that can be employed to or that does (e.g., reversibly) couple the building block to a support, for example, through covalent link, ionic interaction, electrostatic interaction, or hydrophobic interaction.

As used herein, the term “framework” refers to a portion of a building block including the linker or to which the linker is coupled and to which one or more recognition elements are coupled.

As used herein, the term “recognition element” refers to a portion of a building block coupled to the framework but not covalently coupled to the support. Although not limiting to the present invention, the recognition element can provide or form one or more groups, surfaces, or spaces for interacting with the ligand.

As used herein, the phrase “plurality of building blocks” refers to two or more building blocks of different structure in a mixture, in a kit, or on a support or scaffold. Each building block has a particular structure, and use of building blocks in the plural, or of a plurality of building blocks, refers to more than one of these particular structures. Building blocks or plurality of building blocks does not refer to a plurality of molecules each having the same structure.

As used herein, the phrase “combination of building blocks” refers to a plurality of building blocks that together are in a spot, region, or a candidate, lead, or working artificial receptor. A combination of building blocks can be a subset of a set of building blocks. For example, a combination of building blocks can be one of the possible combinations of 2, 3, 4, 5, or 6 building blocks from a set of N (e.g., N=10-200) building blocks.

As used herein, the phrases “homogenous immobilized building block” and “homogenous immobilized building blocks” refer to a support or spot having immobilized on or within it only a single building block.

As used herein, the phrase “activated building block” refers to a building block activated to make it ready to form a covalent bond to a functional group, for example, on a support. A building block including a carboxyl group can be converted to a building block including an activated ester group, which is an activated building block. An activated building block including an activated ester group can react, for example, with an amine to form a covalent bond.

As used herein, the term “naïve” used with respect to one or more building blocks refers to a building block that has not previously been determined or known to bind to a test ligand of interest. For example, the recognition element(s) on a naïve building block has not previously been determined or known to bind to a test ligand of interest. A building block that is or includes a known ligand (e.g., GMI) for a particular protein (test ligand) of interest (e.g., cholera toxin) is not naïve with respect to that protein (test ligand).

As used herein, the term “immobilized” used with respect to building blocks coupled to a support refers to building blocks being stably oriented on the support so that they do not migrate on the support or release from the support. Building blocks can be immobilized by covalent coupling, by ionic interactions, by electrostatic interactions, such as ion pairing, or by hydrophobic interactions, such as van der Waals interactions.

As used herein a “region” of a support, tube, well, or surface refers to a contiguous portion of the support, tube, well, or surface. Building blocks coupled to a region can refer to building blocks in proximity to one another in that region.

As used herein, a “bulky” group on a molecule is larger than a moiety including 7 or 8 carbon atoms.

As used herein, a “small” group on a molecule is hydrogen, methyl, or another group smaller than a moiety including 4 carbon atoms.

As used herein, the term “lawn” refers to a layer, spot, or region of functional groups on a support, for example, at a density sufficient to place coupled building blocks in proximity to one another. The functional groups can include groups capable of forming covalent, ionic, electrostatic, or hydrophobic interactions with building blocks.

As used herein, the term “alkyl” refers to saturated aliphatic groups, including straight-chain alkyl groups, branched-chain alkyl groups, cycloalkyl (alicyclic) groups, alkyl substituted cycloalkyl groups, and cycloalkyl substituted alkyl groups. In certain embodiments, a straight chain or branched chain alkyl has 30 or fewer carbon atoms in its backbone (e.g., C₁-C₁₂ for straight chain, C₁-C₆ for branched chain). Likewise, cycloalkyls can have from 3-10 carbon atoms in their ring structure, for example, 5, 6 or 7 carbons in the ring structure.

The term “alkyl” as used herein refers to both “unsubstituted alkyls” and “substituted alkyls”, the latter of which refers to alkyl moieties having substituents replacing a hydrogen on one or more carbons of the hydrocarbon backbone. Such substituents can include, for example, a halogen, a hydroxyl, a carbonyl (such as a carboxyl, an ester, a formyl, or a ketone), a thiocarbonyl (such as a thioester, a thioacetate, or a thioformate), an alkoxyl, a phosphoryl, a phosphonate, a phosphinate, an amino, an amido, an amidine, an imine, a cyano, a nitro, an azido, a sulfhydryl, an alkylthio, a sulfate, a sulfonate, a sulfamoyl, a sulfonamido, a sulfonyl, a heterocyclyl, an aryl alkyl, or an aromatic or heteroaromatic moiety. The moieties substituted on the hydrocarbon chain can themselves be substituted, if appropriate. For example, the substituents of a substituted alkyl can include substituted and unsubstituted forms of the groups listed above.

The phrase “aryl alkyl”, as used herein, refers to an alkyl group substituted with an aryl group (e.g., an aromatic or heteroaromatic group).

As used herein, the terms “alkenyl” and “alkynyl” refer to unsaturated aliphatic groups analogous in length and optional substitution to the alkyls groups described above, but that contain at least one double or triple bond respectively.

The term “aryl” as used herein includes 5-, 6- and 7-membered single-ring aromatic groups that may include from zero to four heteroatoms, for example, benzene, pyrrole, furan, thiophene, imidazole, oxazole, thiazole, triazole, pyrazole,-pyridine, pyrazine, pyridazine and pyrimidine, and the like. Those aryl groups having heteroatoms in the ring structure may also be referred to as “aryl heterocycles” or “heteroaromatics”. The aromatic ring can be substituted at one or more ring positions with such substituents such as those described above for alkyl groups. The term “aryl” also includes polycyclic ring systems having two or more cyclic rings in which two or more carbons are common to two adjoining rings (the rings are “fused rings”) wherein at least one of the rings is aromatic, e.g., the other cyclic ring(s) can be cycloalkyls, cycloalkenyls, cycloalkynyls, aryls and/or heterocyclyls.

As used herein, the terms “heterocycle” or “heterocyclic group” refer to 3- to 12-membered ring structures, e.g., 3- to 7-membered rings, whose ring structures include one to four heteroatoms. Heterocyclyl groups include, for example, thiophene, thianthrene, furan, pyran, isobenzofuran, chromene, xanthene, phenoxathiin, pyrrole, imidazole, pyrazole, isothiazole, isoxazole, pyridine, pyrazine, pyrimidine, pyridazine, indolizine, isoindole, indole, indazole, purine, quinolizine, isoquinoline, quinoline, phthalazine, naphthyridine, quinoxaline, quinazoline, cinnoline, pteridine, carbazole, carboline, phenanthridine, acridine, pyrimidine, phenanthroline, phenazine, phenarsazine, phenothiazine, furazan, phenoxazine, pyrrolidine, oxolane, thiolane, oxazole, piperidine, piperazine, morpholine, lactones, lactams such as azetidinones and pyrrolidinones, sultams, sultones, and the like. The heterocyclic ring can be substituted at one or more positions with such substituents such as those described for alkyl groups.

As used herein, the term “heteroatom” as used herein means an atom of any element other than carbon or hydrogen, such as nitrogen, oxygen, sulfur and phosphorous.

Overview of the Artificial Receptor

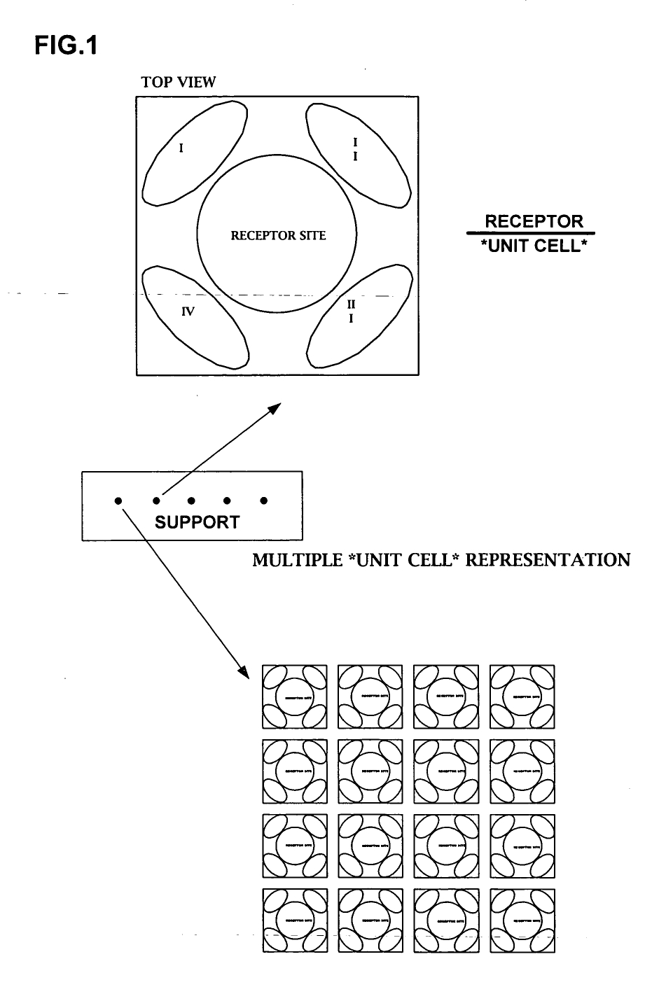

FIG. 1 schematically illustrates an embodiment employing 4 distinct building blocks in a spot on a microarray to make a ligand binding site. This Figure illustrates a group of 4 building blocks at the corners of a square forming a unit cell. A group of four building blocks can be envisioned as the vertices on any quadrilateral. FIG. 1 illustrates that spots or regions of building blocks can be envisioned as multiple unit cells, in this illustration square unit cells. Groups of unit cells of four building blocks in the shape of other quadrilaterals can also be formed on a support.

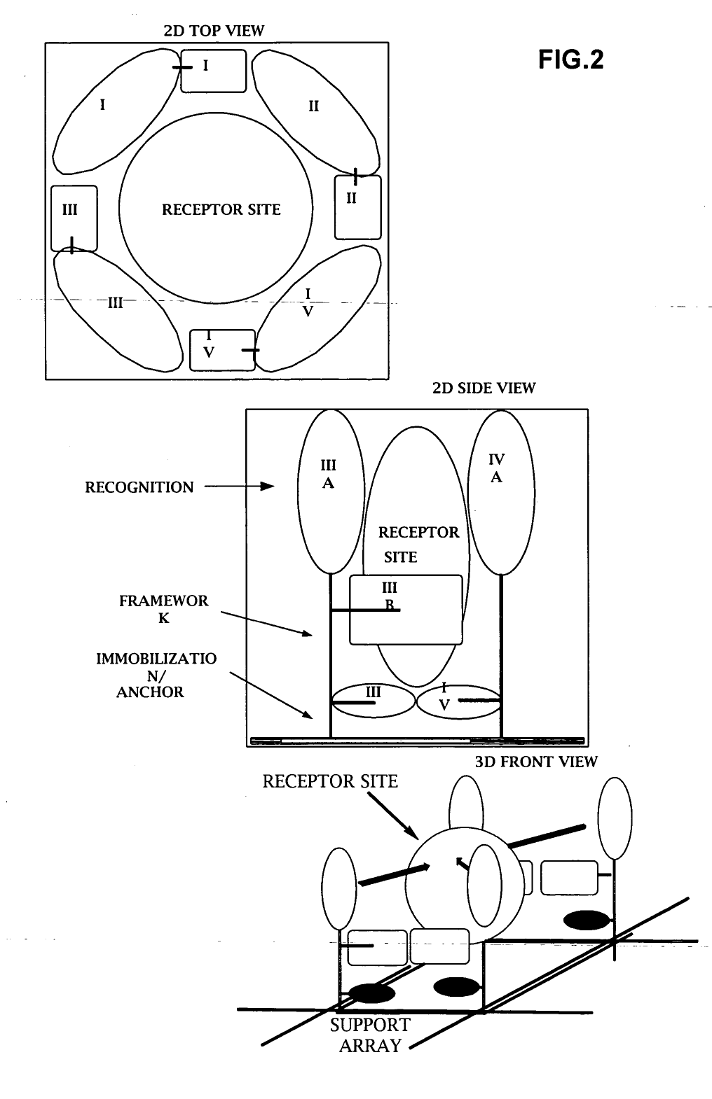

Each immobilized building block molecule can provide one or more “arms” extending from a “framework” and each can include groups that interact with a ligand or with portions of another immobilized building block. FIG. 2 illustrates that combinations of four building blocks, each including a framework with two arms (called “recognition elements”), provides a molecular configuration of building blocks that form a site for binding a ligand. Such a site formed by building blocks such as those exemplified below can bind a small molecule, such as a drug, metabolite, pollutant, or the like, and/or can bind a larger ligand such as a macromolecule or microbe.

The present artificial receptors can include building blocks reversibly immobilized on a support or surface. Reversing immobilization of the building blocks can allow movement of building blocks to a different location on the support or surface, or exchange of building blocks onto and off of the surface. For example, the combinations of building blocks can bind a ligand when reversibly coupled to or immobilized on the support. Reversing the coupling or immobilization of the building blocks provides opportunity for rearranging the building blocks, which can improve binding of the ligand. Further, the present invention can allow for adding additional or different building blocks, which can further improve binding of a ligand.

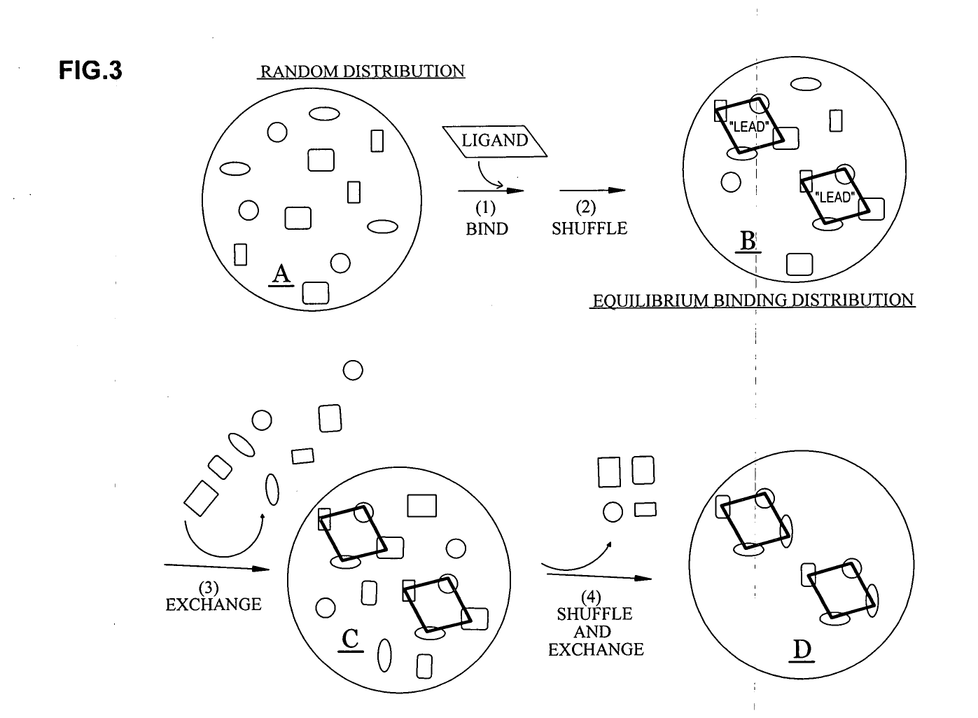

FIG. 3 schematically illustrates an embodiment employing an initial artificial receptor surface (A) with four different building blocks on the surface, which are represented by shaded shapes. This initial artificial receptor surface (A) undergoes (1) binding of a ligand to an artificial receptor and (2) shuffling the building blocks on the receptor surface to yield a lead artificial receptor (B). Shuffling refers to reversing the coupling or immobilization of the building blocks and allowing their rearrangement on the receptor surface. After forming a lead artificial receptor, additional building blocks can be (3) exchanged onto and/or off of the receptor surface (C). Exchanging refers to building blocks leaving the surface and entering a solution contacting the surface and/or building blocks leaving a solution contacting the surface and becoming part of the artificial receptor. The additional building blocks can be selected for structural diversity (e.g., randomly) or selected based on the structure of the building blocks in the lead artificial receptor to provide additional avenues for improving binding. The original and additional building blocks can then be (4) shuffled and exchanged to provide higher affinity artificial receptors on the surface (D).

### Embodiments of Artificial Receptors

In an embodiment, a plurality of building blocks including both hydrophobic and hydrophilic building blocks can be envisioned as forming an artificial receptor with a hydrophilic interior and a hydrophobic periphery, or vice versa. For example, certain of the positional isomers of the plurality of building blocks on a support will be arranged with hydrophobic building blocks surrounded by hydrophilic building blocks. For example, certain of the positional isomers of the plurality of building blocks on a support will be arranged with hydrophilic building blocks surrounded by hydrophobic building blocks.

In an embodiment, the present artificial receptor can include a support or scaffold having more than one side. For example, the support can be a small, even microscopic, with two opposing sides or surfaces. In an embodiment, each of the two opposing sides or surfaces can include an artificial receptor according to the present invention. The artificial receptors can be the same or different. For example, a first receptor on a first side can be specific for a particle and a second receptor on a second side can be specific for a cell or tissue. Such a receptor can be employed for coupling the particle to the cell or tissue. In an embodiment, a first receptor on a first side can be lipophilic and a second receptor on a second side can be hydrophilic. In an embodiment, a first receptor on a first side can be specific for one or more ligands in a cell membrane or liposome and a second receptor on a second side can be specific for a cell, tissue, serum protein, antibody, or soluble molecule.

In an embodiment, two or more building blocks on a support can be coupled to one another. For example, a first and second building block can be coupled covalently or noncovalently. In an embodiment, one or more building blocks can be reversibly coupled employing a moiety that interacts with the building blocks only through reversible interactions. That is, the coupling moiety is not a permanent part of or irreversibly coupled to a building block. For example, the coupling moiety can be configured to form one or more noncovalent or reversible covalent interactions with one or more building blocks. Suitable moieties for such interactions are described herein and in the applications incorporated herein by reference.

In an embodiment, the coupling moiety can be envisioned as retaining or can be employed to retain building blocks in a configuration suitable for binding a particular test ligand. For example, a method according to the present invention can include contacting one or more candidate artificial receptors with a test ligand and at least one coupling moiety. The method can also include selecting those artificial receptors that bind the test ligand in the presence of a particular coupling moiety but not (or more weakly) in the absence of the coupling moiety as an allosteric artificial receptor for that test ligand. In an embodiment, such a method employs a tether building block.

In an embodiment, the present artificial receptor can include one or more latent reactive moieties. The latent reactive moiety can be selected for coupling a protein or another test ligand to the building block. For example, the latent reactive moiety can include a vicinal diol which can be activated to react with a protein with, for example, sodium periodate.

In an embodiment, one or more building blocks according to the present invention can bind a metal. For example, one or more building blocks with a pyridine, carboxylate, phenol, or alcohol moiety can be envisioned as binding a metal.

In an embodiment, the artificial receptor includes a signaling moiety. The signaling moiety can be a building block. The signaling moiety can be a fluorescent or colored moiety. In an embodiment the signaling moiety can be a reactive moiety. For example, the signaling moiety can be a reactive group. After a preselected reaction, the reactive group can be a building block that completes a working artificial receptor for a preselected ligand. Binding of the preselected ligand to the working artificial receptor indicates that the reaction has occurred. The reactive group can be a substrate for an enzyme.

In an embodiment, the present artificial receptor can include one or more building blocks reversibly coupled to one or more building blocks that are coupled to the surface of the support. For example, the present artificial receptor can include one or more building blocks having one or more lipophilic moieties, which can retain that building block on the surface of or in the building blocks coupled to the surface of the support.

In an embodiment, the receptor surface including reversibly immobilized building blocks employing hydrophobic interactions for immobilization can be used as a model for processes on liposomes or lipid bilayer membranes, such as cell surfaces. In an embodiment, such a receptor can be employed to study interactions between proteins.

In an embodiment, the receptor surface including reversibly immobilized building blocks employing hydrophilic interactions (e.g., hydrogen bonding) for immobilization can be used as a model for processes on liposomes or lipid bilayer membranes, such as cell surfaces. In an embodiment, such a receptor can be employed to study interactions between proteins.

In an embodiment, a building block can be reversibly immobilized on a support. A reversibly immobilized support can be, for example, shuffled and/or exchanged. Before or after a reversibly immobilized building block has been shuffled or exchanged it can optionally be permanently immobilized on the support. For example, the building block can include a photo active group. The photo active group can be induced to react with a functional group on the lawn by exposing the artificial receptor to light. Suitable photo active groups are well known and commercially available.

In an embodiment, a lawn can be selected or modified to provide advantageously low levels of nonspecific or background binding to a support including one or more of the present artificial receptors. For example, an amine lawn can be modified with 3-phenylpropionyl chloride to provide a phenethyl modified lawn. Such a lawn can exhibit reduced background binding of certain proteins. In fact, in an embodiment, a phenethyl modified lawn did not significantly bind the protein phycoerythrin compared to the artificial receptors on the support. In an embodiment, the lawn can be modified with one or more building blocks. For example, the building block TyrA8B8 has been observed to produce low and/or uniform backgrounds for receptors being probed with one or more proteins.

In an embodiment, a lawn can include one or more moieties selected to provide a particular property or character to the lawn. For example, the lawn moiety can include a chelator and/or a metal. The lawn moiety can include a hydrophobic moiety that increases LogP for the surface or a hydrophilic moiety that decreases LogP for the surface. The lawn can include moieties of different sizes which can increase or decrease the distance between the support and the building block. In addition, lawn moieties of different sizes can provide varying degrees of mobility to the building block. The lawn moiety can include polar or polarizable moieties. The lawn moiety can include charged moieties, such as negatively charged or positively charged moieties. The lawn moiety can include reactive or latently reactive groups. For example, the lawn can include a lactone, a tertiary amine, a heterocyclic amine, or an acid chloride.

In an embodiment, a lawn moiety can include one or more latent reactive moieties. The latent reactive moiety can be selected for coupling a protein or another test ligand to the building block. For example, the latent reactive moiety can include a vicinal diol which can be activated to react with a protein with, for example, sodium periodate.

Building Blocks

The present invention relates to artificial receptors, arrays or microarrays of artificial receptors or candidate artificial receptors, and methods of making them. Each member of the array includes a plurality of building block compounds, typically immobilized in a spot on a support. The present invention also includes the building blocks, combinations of building blocks, arrays of building blocks, and receptors constructed of these building blocks together with a support. The present invention also includes methods of using these arrays and receptors.

The present invention relates to building blocks for making or forming candidate artificial receptors. A building block can provide one or more structural characteristics such as positive charge, negative charge, acid, base, electron acceptor, electron donor, hydrogen bond donor, hydrogen bond acceptor, free electron pair, π electrons, charge polarization, hydrophilicity, hydrophobicity, and the like. A building block can be bulky or it can be small.

For example, the building block can include one or more carboxyl, amine, hydroxyl, phenol, carbonyl, and thiol groups, which can be a recognition moiety. For example, the building block can include one or more moieties with positive charge, negative charge, acid, base, electron acceptor, electron donor, hydrogen bond donor, hydrogen bond acceptor, free electron pair, π electrons, charge polarization, hydrophilicity, hydrophobicity, and the like.

A description of general and specific features and functions of a variety of building blocks and their synthesis can be found in copending U.S. patent application Ser. No. 10/244,727, filed Sep. 16, 2002, and Application No. PCT/US03/05328, filed Feb. 19, 2003, each entitled “ARTIFICIAL RECEPTORS, BUILDING BLOCKS, AND METHODS”, U.S. patent application Ser. No. 10/813,612, filed Mar. 29, 2004, entitled “ARTIFICIAL RECEPTORS INCLUDING REVERSIBLY IMMOBILIZED BUILDING BLOCKS, THE BUILDING BLOCKS, AND METHODS”; U.S. patent application Ser. No. 10/934,865, filed Sep. 3, 2004, entitled “BUILDING BLOCKS FOR ARTIFICIAL RECEPTORS” and U.S. patent application Ser. No. ______, filed Sep. 1, 2005, the disclosures of which are incorporated herein by reference in their entirety. These patent documents include, in particular, a detailed written description of: function, structure, and configuration of building blocks, framework moieties, recognition elements, synthesis of building blocks, specific embodiments of building blocks, specific embodiments of recognition elements, and sets of building blocks.

### Embodiments of Building Blocks

In an embodiment, a building block can include one or more latent reactive moieties. The latent reactive moiety can be selected for coupling a protein or another test ligand to the building block. For example, the latent reactive moiety can include a vicinal diol which can be activated to react with a protein with, for example, sodium periodate.

In an embodiment, the building block can include an oligo amide or an oligo ether. The oligo amide or an oligo ether can be envisioned as a recognition element. For example, the oligo amide can be an oligo acetamide. For example, the oligo ether can be an oligo ethoxy or propoxy moiety. Although not limiting to the present invention, it is believed that such building blocks may be useful for decreasing protein binding. For example, such building blocks may reduce background when employed as a lawn.

In an embodiment, building blocks can be coupled to one another employing moieties that can form a covalent bond. For example, a building block including an alkyne moiety can be coupled to a building block including an azide moiety. Although not limiting to the present invention, it is believed that such a moiety can be biologically stable but when brought into proximity can react to form a covalent bond.

In an embodiment, the building block can be a peptide or peptidomimetic of Formula A:
R₁R₂N—R₃—(R₄)ₙ—X—(R₅)ₘ—Y—C(O)—R₆
in which
R₁ and R₂ can independently be hydrogen or any suitable blocking or protecting group for an amino-terminal nitrogen of a peptide. Suitable blocking or protecting groups include those described in Green, TW; Wuts, PGM (1999), Protective Groups in Organic Synthesis Third Edition, Wiley-Interscience, New York, 779 pp. In an embodiment, R₁ or R₂ is hydrogen. In an embodiment, R₁ is hydrogen and R₂ is R₇(O)C—, in which R₇ can be lower (e.g., C1 to C6) alkyl, substituted lower (e.g., C1 to C6) alkyl, aryl, substituted aryl, or the like. In an embodiment, R₁ is hydrogen and R₂ is CH₃(O)C—. In an embodiment, R₁ and R₂ are hydrogen.

R₃ can be absent or can be an amino acid, for example, an amino acid with a heteroatom on its side chain. Such amino acids include arginine, lysine, aspartic acid, glutamic acid, cysteine, glutamine, histidine, leucine, valine, methionine, phenylalanine, tyrosine, serine, threonine, and tryptophan. In an embodiment, R₃ is arginine, lysine, aspartic acid, glutamic acid, cysteine, tyrosine, serine, or threonine. In an embodiment, R₃ is arginine, lysine, aspartic acid, or glutamic acid. In an embodiment, R₃ is arginine or lysine. In an embodiment, R₃ is lysine.

n can be 0, or n can be, for example, 1-25. In an embodiment, n=4-16. In an embodiment, n=3-6. In an embodiment, n=4.

Each of the n R₄ can independently be an amino acid. Suitable amino acids include any of the 20 naturally occurring amino acids. Each of the n R₄ can independently be an amino acid with a small or unreactive side chain. In an embodiment, each of the n R₄ is independently alanine, valine, proline, or glycine. In an embodiment, each of the n R₄ is independently alanine or glycine. In an embodiment, each of the R₄ is independently alanine or glycine and n=4. In an embodiment, each of the (F₄)ₙ is -Ala-Gly-Ala-Gly-.

m can be 0, or m can be, for example, 1-6. In an embodiment, m=1-3. In an embodiment, m=1. In an embodiment, m=2.

Each of the m R₅ can independently be an amino acid. Suitable amino acids include any of the 20 naturally occurring amino acids. Each of the m R₅ can independently be an amino acid with a small or unreactive side chain. In an embodiment, each of the m R₅ is independently alanine, valine, proline, or glycine. In an embodiment, each of the m R₅ is independently alanine or glycine. In an embodiment, R₅ is alanine or glycine and m=1. In an embodiment, R₅ is glycine and m=1. In an embodiment, R₅ is alanine and m=1.

In an embodiment, (R₅)ₘ has the formula —NR₈—R₉—CO— in which R₈ can be H or an organic moiety and R₉ can be an organic moiety. In certain embodiments, R₈ is H, lower (e.g., C1 to C6) alkyl, substituted lower (e.g., C1 to C6) alkyl, aryl, substituted aryl, or the like; and R₉ is lower (e.g., C1 to C6) alkyl, substituted lower (e.g., C1 to C6) alkyl, aryl, substituted aryl, or the like. In certain embodiments, R₈ is H; and R₉ is lower (e.g., C1 to C6) alkyl (e.g., branched lower alkyl).

X and Y can independently be an amino acid, a dipeptide moiety (e.g., two amino acids linked by a peptide bond) or a tripeptide moiety (e.g., three amino acids linked by peptide bonds). Suitable amino acids include any of the 20 naturally occurring amino acids. Suitable dipeptide moieties include any two of the 20 naturally occurring amino acids. Suitable tripeptide moieties include any three of the 20 naturally occurring amino acids. In an embodiment, the amino acid or amino acids include or are arginine, glutamine, histidine, leucine, valine, methionine, phenylalanine, tyrosine, serine, threonine, or tryptophan. In an embodiment, the amino acid or amino acids include or are argininei glutamine, histidine, methionine, threonine, tryptophan, aspartic acid, glutamic acid, leucine, phenylalanine, asparagine, isoleucine, serine, valine, tyrosine, or alanine.

In an embodiment, X and Y are independently arginine, glutamine, histidine, methionine, threonine, tryptophan, aspartic acid, glutamic acid, leucine, phenylalanine, asparagine, isoleucine, serine, valine, tyrosine, or alanine. In an embodiment, X is arginine, glutamine, histidine, methionine, threonine, tryptophan, aspartic acid, glutamic acid, leucine, phenylalanine, asparagine, isoleucine, serine, valine, tyrosine, or alanine. In an embodiment, Y is arginine, glutamine, histidine, methionine, threonine, tryptophan, aspartic acid, glutamic acid, leucine, phenylalanine, asparagine, isoleucine, serine, valine, tyrosine, or alanine.

In an embodiment, X and Y are independently arginine, glutamine, histidine, methionine, tyrosine, threonine, or tryptophan. In an embodiment, X is arginine, glutamine, histidine, methionine, tyrosine, threonine, or tryptophan. In an embodiment, Y is arginine, glutamine, histidine, methionine, tyrosine, threonine, or tryptophan.

R₆ can be hydrogen or any suitable blocking or protecting group for an carboxyl-terminal carboxyl group of a peptide. Suitable blocking or protecting groups include those described in Green, T W; Wuts, P G M (1999), Protective Groups in Organic Synthesis Third Edition, Wiley-Interscience, New York, 779 pp. In an embodiment, R₆ is hydrogen. In an embodiment, R₆ is —XR₁₀, in which X is a heteroatom such as N, O, or S and R₁₀ is lower (e.g., C1 to C6) alkyl, substituted lower (e.g., C1 to C6) alkyl, aryl, substituted aryl, or the like. In an embodiment, R₆ is —NHCH₃.

In an embodiment, the building block can be a peptide of Formula B:
H₂N-(Gly)ₙ-(Leu or Phe)-X—Y
in which n=3-16 (e.g., 3) and X and Y are independently amino acids such as arginine, glutamine, histidine, leucine, valine, methionine, phenylalanine, tyrosine, serine, threonine, or tryptophan.

In an embodiment, the building block can be a peptide of Formula C:
H₂N-Z-Ala-Gly-Ala-Gly-X-Gly-Y—R
in which X and Y are independently amino acids such as arginine, glutamine, histidine, leucine, valine, methionine, phenylalanine, tyrosine, serine, threonine, or tryptophan. In an embodiment, Z can be glycine or lysine. In an embodiment, R can be carboxyl (e.g., —COOH or COO—) or —C(O)NHCH₃. In an embodiment, X and Y are independently arginine, glutamine, histidine, methionine, threonine, or tryptophan. In an embodiment, X and Y are independently aspartic acid, glutamic acid, leucine, phenylalanine, asparagine, isoleucine, serine, or valine.

In certain embodiments, the building blocks include those of formulas C1 through C50, D1 through D50, E1 through E50, or the others shown in Scheme 1, below.

Scheme 1:

| | POS 1 | POS 2 | POS 3 | POS 4 | POS 5 | POS 6 | POS 7 | POS 8 |
|---|---|---|---|---|---|---|---|---|
| 1 | GLY | ALA | GLY | ALA | GLY | ARG | GLY | GLN |
| 2 | GLY | ALA | GLY | ALA | GLY | ARG | GLY | HIS |
| 3 | GLY | ALA | GLY | ALA | GLY | ARG | GLY | MET |
| 4 | GLY | ALA | GLY | ALA | GLY | ARG | GLY | THR |
| 5 | GLY | ALA | GLY | ALA | GLY | ARG | GLY | TRP |
| 6 | GLY | ALA | GLY | ALA | GLY | ARG | GLY | TYR |
| 7 | GLY | ALA | GLY | ALA | GLY | GLN | GLY | HIS |
| 8 | GLY | ALA | GLY | ALA | GLY | GLN | GLY | MET |
| 9 | GLY | ALA | GLY | ALA | GLY | GLN | GLY | THR |
| 10 | GLY | ALA | GLY | ALA | GLY | GLN | GLY | TRP |
| 11 | GLY | ALA | GLY | ALA | GLY | GLN | GLY | TYR |
| 12 | GLY | ALA | GLY | ALA | GLY | HIS | GLY | MET |
| 13 | GLY | ALA | GLY | ALA | GLY | HIS | GLY | THR |
| 14 | GLY | ALA | GLY | ALA | GLY | HIS | GLY | TRP |
| 15 | GLY | ALA | GLY | ALA | GLY | HIS | GLY | TYR |
| 16 | GLY | ALA | GLY | ALA | GLY | MET | GLY | THR |
| 17 | GLY | ALA | GLY | ALA | GLY | MET | GLY | TRP |
| 18 | GLY | ALA | GLY | ALA | GLY | MET | GLY | TYR |
| 19 | GLY | ALA | GLY | ALA | GLY | THR | GLY | TRP |
| 20 | GLY | ALA | GLY | ALA | GLY | THR | GLY | TYR |
| 21 | GLY | ALA | GLY | ALA | GLY | TRP | GLY | TYR |
| 22 | GLY | ALA | GLY | ALA | GLY | ASP | GLY | ASP |
| 23 | GLY | ALA | GLY | ALA | GLY | GLU | GLY | GLU |
| 24 | GLY | ALA | GLY | ALA | GLY | LEU | GLY | LEU |
| 25 | GLY | ALA | GLY | ALA | GLY | PHE | GLY | PHE |
| 26 | GLY | ALA | GLY | ALA | GLY | ASN | GLY | ASN |
| 27 | GLY | ALA | GLY | ALA | GLY | ILE | GLY | ILE |
| 28 | GLY | ALA | GLY | ALA | GLY | SER | GLY | SER |
| 29 | GLY | ALA | GLY | ALA | GLY | VAL | GLY | VAL |
| 30 | GLY | ALA | GLY | ALA | GLY | TYR | ALA | ARG |
| 31 | GLY | ALA | GLY | ALA | GLY | TYR | ALA | GLN |
| 32 | GLY | ALA | GLY | ALA | GLY | TYR | ALA | HIS |
| 33 | GLY | ALA | GLY | ALA | GLY | TYR | ALA | MET |
| 34 | GLY | ALA | GLY | ALA | GLY | TYR | ALA | THR |
| 35 | GLY | ALA | GLY | ALA | GLY | TYR | ALA | TRP |
| 36 | GLY | ALA | GLY | ALA | GLY | TRP | ALA | ARG |
| 37 | GLY | ALA | GLY | ALA | GLY | TRP | ALA | GLN |
| 38 | GLY | ALA | GLY | ALA | GLY | TRP | ALA | HIS |
| 39 | GLY | ALA | GLY | ALA | GLY | TRP | ALA | MET |
| 40 | GLY | ALA | GLY | ALA | GLY | TRP | ALA | THR |
| 41 | GLY | ALA | GLY | ALA | GLY | THR | ALA | ARG |
| 42 | GLY | ALA | GLY | ALA | GLY | THR | ALA | GLN |
| 43 | GLY | ALA | GLY | ALA | GLY | THR | ALA | HIS |
| 44 | GLY | ALA | GLY | ALA | GLY | THR | ALA | MET |
| 45 | GLY | ALA | GLY | ALA | GLY | MET | ALA | ARG |
| 46 | GLY | ALA | GLY | ALA | GLY | MET | ALA | GLN |
| 47 | GLY | ALA | GLY | ALA | GLY | MET | ALA | HIS |
| 48 | GLY | ALA | GLY | ALA | GLY | HIS | ALA | ARG |
| 49 | GLY | ALA | GLY | ALA | GLY | HIS | ALA | GLN |
| 50 | GLY | ALA | GLY | ALA | GLY | GLN | ALA | ARG |

| | N-TERM | POS 1 | POS 2 | POS 3 | POS 4 | POS 5 | POS 6 | POS 7 | POS 8 | C-TERM |
|---|---|---|---|---|---|---|---|---|---|---|
| 1 | *H2N—* | LYS | ALA | GLY | ALA | GLY | ARG | GLY | GLN | *—COOH* |
| 2 | *H2N—* | LYS | ALA | GLY | ALA | GLY | ARG | GLY | HIS | *—COOH* |
| 3 | *H2N—* | LYS | ALA | GLY | ALA | GLY | ARG | GLY | MET | *—COOH* |
| 4 | *H2N—* | LYS | ALA | GLY | ALA | GLY | ARG | GLY | THR | *—COOH* |
| 5 | *H2N—* | LYS | ALA | GLY | ALA | GLY | ARG | GLY | TRP | *—COOH* |
| 6 | *H2N—* | LYS | ALA | GLY | ALA | GLY | ARG | GLY | TYR | *—COOH* |
| 7 | *H2N—* | LYS | ALA | GLY | ALA | GLY | GLN | GLY | HIS | *—COOH* |
| 8 | *H2N—* | LYS | ALA | GLY | ALA | GLY | GLN | GLY | MET | *—COOH* |
| 9 | *H2N—* | LYS | ALA | GLY | ALA | GLY | GLN | GLY | THR | *—COOH* |
| 10 | *H2N—* | LYS | ALA | GLY | ALA | GLY | GLN | GLY | TRP | *—COOH* |
| 11 | *H2N—* | LYS | ALA | GLY | ALA | GLY | GLN | GLY | TYR | *—COOH* |
| 12 | *H2N—* | LYS | ALA | GLY | ALA | GLY | HIS | GLY | MET | *—COOH* |
| 13 | *H2N—* | LYS | ALA | GLY | ALA | GLY | HIS | GLY | THR | *—COOH* |
| 14 | *H2N—* | LYS | ALA | GLY | ALA | GLY | HIS | GLY | TRP | *—COOH* |
| 15 | *H2N—* | LYS | ALA | GLY | ALA | GLY | HIS | GLY | TYR | *—COOH* |
| 16 | *H2N—* | LYS | ALA | GLY | ALA | GLY | MET | GLY | THR | *—COOH* |
| 17 | *H2N—* | LYS | ALA | GLY | ALA | GLY | MET | GLY | TRP | *—COOH* |
| 18 | *H2N—* | LYS | ALA | GLY | ALA | GLY | MET | GLY | TYR | *—COOH* |
| 19 | *H2N—* | LYS | ALA | GLY | ALA | GLY | THR | GLY | TRP | *—COOH* |
| 20 | *H2N—* | LYS | ALA | GLY | ALA | GLY | THR | GLY | TYR | *—COOH* |
| 21 | *H2N—* | LYS | ALA | GLY | ALA | GLY | TRP | GLY | TYR | *—COOH* |
| 22 | *H2N—* | LYS | ALA | GLY | ALA | GLY | ASP | GLY | ASP | *—COOH* |
| 23 | *H2N—* | LYS | ALA | GLY | ALA | GLY | GLU | GLY | GLU | *—COOH* |
| 24 | *H2N—* | LYS | ALA | GLY | ALA | GLY | LEU | GLY | LEU | *—COOH* |
| 25 | *H2N—* | LYS | ALA | GLY | ALA | GLY | PHE | GLY | PHE | *—COOH* |
| 26 | *H2N—* | LYS | ALA | GLY | ALA | GLY | ASN | GLY | ASN | *—COOH* |
| 27 | *H2N—* | LYS | ALA | GLY | ALA | GLY | ILE | GLY | ILE | *—COOH* |
| 28 | *H2N—* | LYS | ALA | GLY | ALA | GLY | SER | GLY | SER | *—COOH* |
| 29 | *H2N—* | LYS | ALA | GLY | ALA | GLY | VAL | GLY | VAL | *—COOH* |
| 30 | *H2N—* | LYS | ALA | GLY | ALA | GLY | TYR | ALA | ARG | *—COOH* |
| 31 | *H2N—* | LYS | ALA | GLY | ALA | GLY | TYR | ALA | GLN | *—COOH* |
| 32 | *H2N—* | LYS | ALA | GLY | ALA | GLY | TYR | ALA | HIS | *—COOH* |
| 33 | *H2N—* | LYS | ALA | GLY | ALA | GLY | TYR | ALA | MET | *—COOH* |
| 34 | *H2N—* | LYS | ALA | GLY | ALA | GLY | TYR | ALA | THR | *—COOH* |
| 35 | *H2N—* | LYS | ALA | GLY | ALA | GLY | TYR | ALA | TRP | *—COOH* |
| 36 | *H2N—* | LYS | ALA | GLY | ALA | GLY | TRP | ALA | ARG | *—COOH* |
| 37 | *H2N—* | LYS | ALA | GLY | ALA | GLY | TRP | ALA | GLN | *—COOH* |
| 38 | *H2N—* | LYS | ALA | GLY | ALA | GLY | TRP | ALA | HIS | *—COOH* |
| 39 | *H2N—* | LYS | ALA | GLY | ALA | GLY | TRP | ALA | MET | *—COOH* |
| 40 | *H2N—* | LYS | ALA | GLY | ALA | GLY | TRP | ALA | THR | *—COOH* |
| 41 | *H2N—* | LYS | ALA | GLY | ALA | GLY | THR | ALA | ARG | *—COOH* |
| 42 | *H2N—* | LYS | ALA | GLY | ALA | GLY | THR | ALA | GLN | *—COOH* |
| 43 | *H2N—* | LYS | ALA | GLY | ALA | GLY | THR | ALA | HIS | *—COOH* |
| 44 | *H2N—* | LYS | ALA | GLY | ALA | GLY | THR | ALA | MET | *—COOH* |
| 45 | *H2N—* | LYS | ALA | GLY | ALA | GLY | MET | ALA | ARG | *—COOH* |
| 46 | *H2N—* | LYS | ALA | GLY | ALA | GLY | MET | ALA | GLN | *—COOH* |
| 47 | *H2N—* | LYS | ALA | GLY | ALA | GLY | MET | ALA | HIS | *—COOH* |
| 48 | *H2N—* | LYS | ALA | GLY | ALA | GLY | HIS | ALA | ARG | *—COOH* |
| 49 | *H2N—* | LYS | ALA | GLY | ALA | GLY | HIS | ALA | GLN | *—COOH* |
| 50 | *H2N—* | LYS | ALA | GLY | ALA | GLY | GLN | ALA | ARG | *—COOH* |

| | N-TERM | POS 1 | POS 2 | POS 3 | POS 4 | POS 5 | POS 6 | POS 7 | POS 8 | C-TERM |
|---|---|---|---|---|---|---|---|---|---|---|
| 1 | *H2N—* | LYS | ALA | GLY | ALA | GLY | ARG | GLY | GLN | *—C(O)—NH—CH3* |
| 2 | *H2N—* | LYS | ALA | GLY | ALA | GLY | ARG | GLY | HIS | *—C(O)—NH—CH3* |
| 3 | *H2N—* | LYS | ALA | GLY | ALA | GLY | ARG | GLY | MET | *—C(O)—NH—CH3* |
| 4 | *H2N—* | LYS | ALA | GLY | ALA | GLY | ARG | GLY | THR | *—C(O)—NH—CH3* |
| 5 | *H2N—* | LYS | ALA | GLY | ALA | GLY | ARG | GLY | TRP | *—C(O)—NH—CH3* |
| 6 | *H2N—* | LYS | ALA | GLY | ALA | GLY | ARG | GLY | TYR | *—C(O)—NH—CH3* |
| 7 | *H2N—* | LYS | ALA | GLY | ALA | GLY | GLN | GLY | HIS | *—C(O)—NH—CH3* |
| 8 | *H2N—* | LYS | ALA | GLY | ALA | GLY | GLN | GLY | MET | *—C(O)—NH—CH3* |
| 9 | *H2N—* | LYS | ALA | GLY | ALA | GLY | GLN | GLY | THR | *—C(O)—NH—CH3* |
| 10 | *H2N—* | LYS | ALA | GLY | ALA | GLY | GLN | GLY | TRP | *—C(O)—NH—CH3* |
| 11 | *H2N—* | LYS | ALA | GLY | ALA | GLY | GLN | GLY | TYR | *—C(O)—NH—CH3* |
| 12 | *H2N—* | LYS | ALA | GLY | ALA | GLY | HIS | GLY | MET | *—C(O)—NH—CH3* |
| 13 | *H2N—* | LYS | ALA | GLY | ALA | GLY | HIS | GLY | THR | *—C(O)—NH—CH3* |
| 14 | *H2N—* | LYS | ALA | GLY | ALA | GLY | HIS | GLY | TRP | *—C(O)—NH—CH3* |
| 15 | *H2N—* | LYS | ALA | GLY | ALA | GLY | HIS | GLY | TYR | *—C(O)—NH—CH3* |
| 16 | *H2N—* | LYS | ALA | GLY | ALA | GLY | MET | GLY | THR | *—C(O)—NH—CH3* |
| 17 | *H2N—* | LYS | ALA | GLY | ALA | GLY | MET | GLY | TRP | *—C(O)—NH—CH3* |
| 18 | *H2N—* | LYS | ALA | GLY | ALA | GLY | MET | GLY | TYR | *—C(O)—NH—CH3* |
| 19 | *H2N—* | LYS | ALA | GLY | ALA | GLY | THR | GLY | TRP | *—C(O)—NH—CH3* |
| 20 | *H2N—* | LYS | ALA | GLY | ALA | GLY | THR | GLY | TYR | *—C(O)—NH—CH3* |
| 21 | *H2N—* | LYS | ALA | GLY | ALA | GLY | TRP | GLY | TYR | *—C(O)—NH—CH3* |
| 22 | *H2N—* | LYS | ALA | GLY | ALA | GLY | ASP | GLY | ASP | *—C(O)—NH—CH3* |
| 23 | *H2N—* | LYS | ALA | GLY | ALA | GLY | GLU | GLY | GLU | *—C(O)—NH—CH3* |
| 24 | *H2N—* | LYS | ALA | GLY | ALA | GLY | LEU | GLY | LEU | *—C(O)—NH—CH3* |
| 25 | *H2N—* | LYS | ALA | GLY | ALA | GLY | PHE | GLY | PHE | *—C(O)—NH—CH3* |
| 26 | *H2N—* | LYS | ALA | GLY | ALA | GLY | ASN | GLY | ASN | *—C(O)—NH—CH3* |
| 27 | *H2N—* | LYS | ALA | GLY | ALA | GLY | ILE | GLY | ILE | *—C(O)—NH—CH3* |
| 28 | *H2N—* | LYS | ALA | GLY | ALA | GLY | SER | GLY | SER | *—C(O)—NH—CH3* |
| 29 | *H2N—* | LYS | ALA | GLY | ALA | GLY | VAL | GLY | VAL | *—C(O)—NH—CH3* |
| 30 | *H2N—* | LYS | ALA | GLY | ALA | GLY | TYR | ALA | ARG | *—C(O)—NH—CH3* |
| 31 | *H2N—* | LYS | ALA | GLY | ALA | GLY | TYR | ALA | GLN | *—C(O)—NH—CH3* |
| 32 | *H2N—* | LYS | ALA | GLY | ALA | GLY | TYR | ALA | HIS | *—C(O)—NH—CH3* |
| 33 | *H2N—* | LYS | ALA | GLY | ALA | GLY | TYR | ALA | MET | *—C(O)—NH—CH3* |
| 34 | *H2N—* | LYS | ALA | GLY | ALA | GLY | TYR | ALA | THR | *—C(O)—NH—CH3* |
| 35 | *H2N—* | LYS | ALA | GLY | ALA | GLY | TYR | ALA | TRP | *—C(O)—NH—CH3* |
| 36 | *H2N—* | LYS | ALA | GLY | ALA | GLY | TRP | ALA | ARG | *—C(O)—NH—CH3* |
| 37 | *H2N—* | LYS | ALA | GLY | ALA | GLY | TRP | ALA | GLN | *—C(O)—NH—CH3* |
| 38 | *H2N—* | LYS | ALA | GLY | ALA | GLY | TRP | ALA | HIS | *—C(O)—NH—CH3* |
| 39 | *H2N—* | LYS | ALA | GLY | ALA | GLY | TRP | ALA | MET | *—C(O)—NH—CH3* |
| 40 | *H2N—* | LYS | ALA | GLY | ALA | GLY | TRP | ALA | THR | *—C(O)—NH—CH3* |
| 41 | *H2N—* | LYS | ALA | GLY | ALA | GLY | THR | ALA | ARG | *—C(O)—NH—CH3* |
| 42 | *H2N—* | LYS | ALA | GLY | ALA | GLY | THR | ALA | GLN | *—C(O)—NH—CH3* |
| 43 | *H2N—* | LYS | ALA | GLY | ALA | GLY | THR | ALA | HIS | *—C(O)—NH—CH3* |
| 44 | *H2N—* | LYS | ALA | GLY | ALA | GLY | THR | ALA | MET | *—C(O)—NH—CH3* |
| 45 | *H2N—* | LYS | ALA | GLY | ALA | GLY | MET | ALA | ARG | *—C(O)—NH—CH3* |
| 46 | *H2N—* | LYS | ALA | GLY | ALA | GLY | MET | ALA | GLN | *—C(O)—NH—CH3* |
| 47 | *H2N—* | LYS | ALA | GLY | ALA | GLY | MET | ALA | HIS | *—C(O)—NH—CH3* |
| 48 | *H2N—* | LYS | ALA | GLY | ALA | GLY | HIS | ALA | ARG | *—C(O)—NH—CH3* |
| 49 | *H2N—* | LYS | ALA | GLY | ALA | GLY | HIS | ALA | GLN | *—C(O)—NH—CH3* |
| 50 | *H2N—* | LYS | ALA | GLY | ALA | GLY | GLN | ALA | ARG | *—C(O)—NH—CH3* |

| | N-TERM | POS 1 | POS 2 | POS 3 | POS 4 | POS 5 | POS 6 | POS 7 | POS 8 | C-TERM |
|---|---|---|---|---|---|---|---|---|---|---|
| 1 | *AC—HN—* | LYS | ALA | GLY | ALA | GLY | ARG | GLY | GLN | *—C(O)—NH—CH3* |
| 2 | *AC—HN—* | LYS | ALA | GLY | ALA | GLY | ARG | GLY | HIS | *—C(O)—NH—CH3* |
| 3 | *AC—HN—* | LYS | ALA | GLY | ALA | GLY | ARG | GLY | MET | *—C(O)—NH—CH3* |
| 4 | *AC—HN—* | LYS | ALA | GLY | ALA | GLY | ARG | GLY | THR | *—C(O)—NH—CH3* |
| 5 | *AC—HN—* | LYS | ALA | GLY | ALA | GLY | ARG | GLY | TRP | *—C(O)—NH—CH3* |
| 6 | *AC—HN—* | LYS | ALA | GLY | ALA | GLY | ARG | GLY | TYR | *—C(O)—NH—CH3* |
| 7 | *AC—HN—* | LYS | ALA | GLY | ALA | GLY | GLN | GLY | HIS | *—C(O)—NH—CH3* |
| 8 | *AC—HN—* | LYS | ALA | GLY | ALA | GLY | GLN | GLY | MET | *—C(O)—NH—CH3* |
| 9 | *AC—HN—* | LYS | ALA | GLY | ALA | GLY | GLN | GLY | THR | *—C(O)—NH—CH3* |
| 10 | *AC—HN—* | LYS | ALA | GLY | ALA | GLY | GLN | GLY | TRP | *—C(O)—NH—CH3* |
| 11 | *AC—HN—* | LYS | ALA | GLY | ALA | GLY | GLN | GLY | TYR | *—C(O)—NH—CH3* |
| 12 | *AC—HN—* | LYS | ALA | GLY | ALA | GLY | HIS | GLY | MET | *—C(O)—NH—CH3* |
| 13 | *AC—HN—* | LYS | ALA | GLY | ALA | GLY | HIS | GLY | THR | *—C(O)—NH—CH3* |
| 14 | *AC—HN—* | LYS | ALA | GLY | ALA | GLY | HIS | GLY | TRP | *—C(O)—NH—CH3* |
| 15 | *AC—HN—* | LYS | ALA | GLY | ALA | GLY | HIS | GLY | TYR | *—C(O)—NH—CH3* |
| 16 | *AC—HN—* | LYS | ALA | GLY | ALA | GLY | MET | GLY | THR | *—C(O)—NH—CH3* |
| 17 | *AC—HN—* | LYS | ALA | GLY | ALA | GLY | MET | GLY | TRP | *—C(O)—NH—CH3* |
| 18 | *AC—HN—* | LYS | ALA | GLY | ALA | GLY | MET | GLY | TYR | *—C(O)—NH—CH3* |
| 19 | *AC—HN—* | LYS | ALA | GLY | ALA | GLY | THR | GLY | TRP | *—C(O)—NH—CH3* |
| 20 | *AC—HN—* | LYS | ALA | GLY | ALA | GLY | THR | GLY | TYR | *—C(O)—NH—CH3* |
| 21 | *AC—HN—* | LYS | ALA | GLY | ALA | GLY | TRP | GLY | TYR | *—C(O)—NH—CH3* |
| 22 | *AC—HN—* | LYS | ALA | GLY | ALA | GLY | ASP | GLY | ASP | *—C(O)—NH—CH3* |
| 23 | *AC—HN—* | LYS | ALA | GLY | ALA | GLY | GLU | GLY | GLU | *—C(O)—NH—CH3* |
| 24 | *AC—HN—* | LYS | ALA | GLY | ALA | GLY | LEU | GLY | LEU | *—C(O)—NH—CH3* |
| 25 | *AC—HN—* | LYS | ALA | GLY | ALA | GLY | PHE | GLY | PHE | *—C(O)—NH—CH3* |
| 26 | *AC—HN—* | LYS | ALA | GLY | ALA | GLY | ASN | GLY | ASN | *—C(O)—NH—CH3* |
| 27 | *AC—HN—* | LYS | ALA | GLY | ALA | GLY | ILE | GLY | ILE | *—C(O)—NH—CH3* |
| 28 | *AC—HN—* | LYS | ALA | GLY | ALA | GLY | SER | GLY | SER | *—C(O)—NH—CH3* |
| 29 | *AC—HN—* | LYS | ALA | GLY | ALA | GLY | VAL | GLY | VAL | *—C(O)—NH—CH3* |
| 30 | *AC—HN—* | LYS | ALA | GLY | ALA | GLY | ARG | ALA | ARG | *—C(O)—NH—CH3* |
| 31 | *AC—HN—* | LYS | ALA | GLY | ALA | GLY | GLN | ALA | GLN | *—C(O)—NH—CH3* |
| 32 | *AC—HN—* | LYS | ALA | GLY | ALA | GLY | HIS | ALA | HIS | *—C(O)—NH—CH3* |
| 33 | *AC—HN—* | LYS | ALA | GLY | ALA | GLY | MET | ALA | MET | *—C(O)—NH—CH3* |
| 34 | *AC—HN—* | LYS | ALA | GLY | ALA | GLY | THR | ALA | THR | *—C(O)—NH—CH3* |
| 35 | *AC—HN—* | LYS | ALA | GLY | ALA | GLY | TRP | ALA | TRP | *—C(O)—NH—CH3* |
| 36 | *AC—HN—* | LYS | ALA | GLY | ALA | GLY | TYR | ALA | TYR | *—C(O)—NH—CH3* |
| 37 | *AC—HN—* | LYS | ALA | GLY | ALA | GLY | ALA | GLY | ALA | *—C(O)—NH—CH3* |

Sets of Building Blocks

In an embodiment, building blocks can be considered in sets, such as in a set of structurally heterogeneous small molecules or in a set of molecules with a structural theme. Sets of molecules with structural themes include for example, peptides, carbohydrates, and nucleotides.

In an embodiment, a first set of building blocks includes structurally heterogeneous small molecules. Such a set of building blocks can include those described in U.S. patent application Ser. No. 10/244,727, filed Sep. 16, 2002, Ser. No. 10/813,568, filed Mar. 29, 2004, and Application No. PCT/US03/05328, filed Feb. 19, 2003, each entitled “ARTIFICIAL RECEPTORS, BUILDING BLOCKS, AND METHODS”; or U.S. patent application Ser. Nos. 10/812,850 and 10/813,612, and application No. PCT/US2004/009649, each filed Mar. 29, 2004 and each entitled “ARTIFICIAL RECEPTORS INCLUDING REVERSIBLY IMMOBILIZED BUILDING BLOCKS, THE BUILDING BLOCKS, AND METHODS”; and U.S. patent application Ser. No. 10/934,193 entitled “SENSORS EMPLOYING COMBINATORIAL ARTIFICIAL RECEPTORS”, filed Sep. 3, 2004 and U.S. patent application Ser. No. ______ entitled “COMBINATORIAL ARTIFICIAL RECEPTORS INCLUDING TETHER BUILDING BLOCKS”, filed Sep. 1, 2005; the disclosures of which are incorporated herein by reference.

In an embodiment a second set of building blocks includes peptides. The peptides can include 2 to, for example, 20 amino acids. The set of peptides can be or include the peptides of Formula A, Formula B, or Formula C. Such a set of peptides can be employed in an array for characterizing a proteome, such as a collection of antibodies in serum from an animal (e.g., a human) or another set of proteins.

In an embodiment, the building block is or includes a dipeptide. Any of the 400 dipeptides including the 20 natural amino acids in any order can be employed as building blocks. Suitable dipeptides include muramyl dipeptide or the like.

In an embodiment, a third set of building blocks includes carbohydrates. In an embodiment, the set of building blocks includes a monosaccharides. Any of a variety of naturally occurring or synthetic monosaccharides can be employed as a building block. Suitable monosaccharides include pyranoses and furanoses, such as glucose, fructose, ribulose, allose, altrose, mannose, gulose, idose, galactose, talose, ribose, arabinose, xylose, lyxose, or the like; erythrose, threose, or the like; inositol, or the like; amino sugars, such as rhammose, fucose, glucosamine, galactosamine, N-acetylglucosamine N-acetylgalactosamine, neuraminic acid, N-acetylneuraminic acid, or the like; aldonic and uronic acids, such as gluconic acid, glucuronic acid, glucaric acid, or the like; glycosides including these monosaccharides; or the like. Suitable carbohydrates include a disaccharide or oligosaccharide including one or more of these monosaccharides, such as sucrose, raffinose, gentianose, cellobiose, maltose, lactose, trehalose, gentiobiose, meliobiose, or the like; a mixture or combination thereof, or the like.

In an embodiment, the monosaccharide can be or include glucose, galactose, mannose, fucose, N-acetylglucosamine, a mixture or combination thereof, or the like. In an embodiment, the monosaccharide can be or include glucose, galactose, mannose, fucose, N-acetylglucosamine, N-acetylgalactosamine, N-acetylneuraminic acid, a mixture or combination thereof, or the like. Suitable carbohydrates include a disaccharide or oligosaccharide (e.g., glycan) including one or more of these monosaccharides.

In an embodiment, the building block is or includes a disaccharide. Any of a variety of naturally occurring or synthetic disaccharides can be employed as a building block. Suitable disaccharides include disaccharides or oligosaccharides including the monosaccharides listed above. Such disaccharides include sucrose, raffinose, gentianose, cellobiose, maltose, lactose, trehalose, gentiobiose, meliobiose, or the like; a mixture or combination thereof, or the like.

In an embodiment, the building block is or includes a carbohydrate. Any of a variety of naturally occurring or synthetic carbohydrates can be employed as a building block. Suitable carbohydrates include cellulose, chitin, starch, glycogen, hyaluronic acid, chondroitin sulfates, keratosulfate, heparin, glycoproteins, or the like; a mixture or combination thereof, or the like.

In an embodiment, a fourth set of building blocks includes nucleotides, such as oligonucleotides. Such a set can include AMP, ADP, ATP, GMP, GDP, GTP, CMP, CDP, CTP, TMP, TDP, TTP, UMP, UDP, UTP, or an oligonucleotide (e.g., an oligomer of up to about 15 or 20 nucleotides).

In an embodiment, a set of building blocks can include a mixed set of building blocks including, for example, one or more members of the first set of building blocks, one or more members of the second set of building blocks, one or more members of the third set of building blocks, and/or one or more members of the fourth set of building blocks. For example, a set of building blocks can include one or more small molecules, one or more peptides, one or more carbohydrates, and/or one or more nucleotides.

The present building blocks can be envisioned as fitting into one or more of several classes. For example, a “core” building block can be envisioned as including those building blocks whose framework can be envisioned as a small molecule, such as an amino acid. For example, a “string” building block can be as envisioned as including those building blocks whose framework can be envisioned as a polymer, such as the backbone of a peptide. For example, a “branched” building block can be envisioned as including those building blocks whose framework can be envisioned as a polymer with branches or functional groups suitable for coupling to additional building blocks. For example, a branched building block can include a polyamine framework.

Systems and Methods Employing the Present Artificial Receptors

The present invention includes methods for making an artificial receptor for binding a test ligand. In an embodiment, the method of the present invention can include contacting at least one candidate artificial receptor with a test ligand, detecting binding of the test ligand to at least one candidate artificial receptor, and selecting at least one candidate artificial receptor for which test ligand binding was detected as a working artificial receptor for the test ligand. The candidate artificial receptor can include a plurality of building blocks coupled to a region of a support.

The present invention includes methods for detecting a test ligand. In an embodiment, a method of the invention can include contacting at least one working artificial receptor with a sample suspected of containing the test ligand and monitoring for binding to the at least one working artificial receptor, wherein binding to the at least one working artificial receptor indicates the presence of the test ligand in the sample. The working artificial receptor can include a plurality of building blocks coupled to a region of a support. In an embodiment, the at least one working artificial receptor is known to bind the test ligand. In an embodiment, the at least one working artificial receptor can include a plurality of artificial receptors.

In an embodiment, a method of the present invention can include contacting a plurality of candidate artificial receptors with a first test ligand; detecting binding of the first test ligand to at least one candidate artificial receptor; and cataloging location or composition of the at least one artificial receptor that bound the first test ligand. Each candidate artificial receptor independently can include a plurality of building blocks coupled to a region of a support.

The present invention includes methods for detecting a compound that disrupts an interaction of a test ligand. This method can include contacting at least one working artificial receptor with a test ligand and a candidate disrupter. Contacting can be simultaneous, contacting with test ligand can come before contacting with candidate disruptor, or contacting with candidate disrupter ligand can come before contacting with test ligand. In an embodiment, the method can include contacting at least one working artificial receptor with a mixture comprising the test ligand and a candidate disrupter. The method can also include monitoring for those candidate disruptors that decrease binding of the test ligand to the at least one working artificial receptor, wherein decreased binding indicates that the candidate disrupter is a lead disruptor. The working artificial receptor can include a plurality of building blocks coupled to a region of a support. In an embodiment, the at least one working artificial receptor is known to bind the test ligand.

The present invention includes methods for making an affinity support for a test ligand. In an embodiment, a method of the invention can include contacting at least one candidate artificial receptor with the test ligand; detecting binding of the test ligand to at least one candidate artificial receptor; selecting at least one candidate artificial receptor for which test ligand binding was detected as a working artificial receptor for the test ligand; and coupling the working artificial receptor to a second support to form an affinity support. The candidate artificial receptor can include a plurality of building blocks coupled to a region of a first support.

The present invention includes methods for isolating a test ligand. In an embodiment, a method of the invention can include contacting a sample containing the test ligand with a working artificial receptor. The working artificial receptor can include a plurality of building blocks coupled to a region of a support. In an embodiment, the working artificial receptor is known to bind the test ligand.

The present invention includes methods for making a reaction support for a reactant. In an embodiment, a method of the invention can include contacting at least one candidate artificial receptor with the reactant; detecting binding of the test ligand to at least one candidate artificial receptor; selecting at least one candidate artificial receptor for which test ligand binding was detected as a working artificial receptor for the test ligand; contacting at least one working artificial receptor with the reactant and monitoring for a reaction of the reactant; selecting a working artificial receptor for which the reaction was observed as a reaction artificial receptor; and coupling the reaction artificial receptor to a second support to form a reaction support. The candidate artificial receptor can include a plurality of building blocks coupled to a region of a first support. In an embodiment, the method can include contacting at least one working artificial receptor with a second reactant.

The present invention includes methods for reacting a reactant. In an embodiment, a method of the invention can include contacting a sample containing the reactant with a working artificial receptor. The working artificial receptor can include a plurality of building blocks coupled to a region of a support. In an embodiment, the working artificial receptor is known to bind the test ligand. In an embodiment, the method can include contacting the working artificial receptor with a second reactant.

The present invention includes methods of making a catalytic support for a reactant. In an embodiment, a method of the present invention can include contacting at least one candidate artificial receptor with the reactant; detecting catalysis of a reaction of the reactant in the presence of the at least one candidate artificial receptor; selecting at least one candidate artificial receptor for which catalysis was detected as a working artificial receptor for the test ligand; and coupling the working receptor to a second support to form a catalytic support. The candidate artificial receptor can include a plurality of building blocks coupled to a region of a first support. In an embodiment, the method can include contacting at least one working artificial receptor with a second reactant.

The present invention includes methods of catalyzing a reaction. In an embodiment, a method of the invention can include contacting a sample containing a reactant with a working artificial receptor. The working artificial receptor can include a plurality of building blocks coupled to a region of a support. In an embodiment, the working artificial receptor is known to bind the test ligand and catalyze the reaction.

The present invention includes methods of making a surface that does not bind a test ligand. In an embodiment, a method of the invention can include contacting at least one candidate artificial receptor with the test ligand; detecting lack of binding of the test ligand to at least one candidate artificial receptor; and selecting at least one candidate artificial receptor for which test lack of ligand binding was detected as a nonbinding surface for the test ligand. The candidate artificial receptor can include a plurality of building blocks coupled to a region of a support. In an embodiment, the test ligand comprises a plurality of test ligands.

The present invention includes methods for detecting a compound that disrupts an interaction of a test ligand with a second ligand. In an embodiment, a method of the invention can include binding the test ligand to at least one working artificial receptor. This method can include contacting at least one working artificial receptor with a second ligand and a candidate disruptor. Contacting can be simultaneous, contacting with second ligand can come before contacting with candidate disruptor, or contacting with candidate disruptor ligand can come before contacting with second ligand. In an embodiment, the method can include monitoring for those candidate disruptors that decrease binding of the second ligand to the test ligand wherein decreased binding indicates that the candidate disruptor is a lead disruptor. The working artificial receptor can include a plurality of building blocks coupled to a region of a support. In an embodiment, the at least one working artificial receptor is known to bind the test ligand.

U.S. patent application Ser. No. 10/923,977, filed Sep. 3, 2004, discloses a variety of methods employing the present artificial receptors or building blocks. This application is incorporated herein in its entirety.

### Embodiments of Systems and Methods Employing the Present Artificial Receptors

In an embodiment, the present method includes a method for detecting components of a reaction pathway. Such a method can include, for example, employing one or more components of a reaction pathway as building blocks in one or more artificial receptors according to the present invention. The artificial receptors can be contacted with one or more test ligands that are candidates for being one of the missing components of the reaction pathway. The contacted artificial receptor can be monitored for production of one or more products of the reaction pathway or at a portion of the reaction pathway.

Such a method can include, for example, employing one or more components of a reaction pathway as building blocks in one or more artificial receptors according to the present invention. The set of building blocks can also include one or more candidate missing components of the reaction pathway. The building blocks can be coupled to a support. The resulting artificial receptors can be tested for carrying out the reaction. For example, the artificial receptors can be contacted with a reactant and monitored for producing a product or intermediate of the reaction pathway or portion of the reaction pathway.

Such a method can include, for example, employing one or more components of a reaction pathway as test ligands against a plurality of artificial receptors. The method can include selecting one or more artificial receptors that bind each of the components of the reaction pathway as a working artificial receptor. The method can include contacting the working artificial receptors with a reactant and monitoring for production of a product or intermediate of the reaction pathway or portion of the reaction pathway.

For example, the building blocks can include species useful in photovoltaic cells and test species to be tested for usefulness in photovoltaic cells. The building blocks known to be useful in photovoltaic cells can be employed in various ratios in densities with or without one or more test species. Similarly, the test species can be employed in various ratios are densities with different combinations of the useful building blocks. Candidate artificial receptors can be tested for converting light to energy. Test ligands can be bound to the candidate artificial receptors and they can then be tested for converting light to energy.

In an embodiment, the one or more components of a reaction pathway can be one or more components of electron transfer or transport pathway. For example, the one or more components can include one or more of dihydropyrene, a porphyrin, and fullerene. For example, the one or more components can include one or more components of a biological electron transport system, such as photosynthetic proteins.

In an embodiment, the one or more components of a reaction pathway can be or include one more components of the an enzymatic reaction pathway.

In an embodiment, the present method can include contacting a plurality of artificial receptors with one or more natural products. The method can include removing natural product from one or more of the receptors as isolated natural product. The method can include selecting one or more artificial receptors that bind one or more natural products as working artificial receptors. The method can include employing the one or more working artificial receptors as an affinity support for isolating or purifying the natural product.

In an embodiment, the present method can include employing one or more of the present artificial receptors for molecular recognition. For example, a plurality of artificial receptors can be screened against scaffold bound building blocks and those working receptors that bind the scaffold bound building blocks can be selected as working artificial receptors. The method can then include contacting the working artificial receptor with the building blocks in the presence of a scaffold reagent and coupling the building blocks to the scaffold reagent.

For example, a plurality of artificial receptors can be screened against a test ligand of interest. The method can include selecting artificial receptors that bind the test ligand of interest as working artificial receptors. The working artificial receptors can be screened against unknown test ligands. Those unknown test ligands that bind to the working artificial receptors can be selected as analog to the test ligand of interest. For example, working artificial receptors that bind taxol or a feature of taxol can be employed to find analogs of taxol or the feature of taxol.

In an embodiment, a working artificial receptor according to the present invention can be employed in a blood bag. Such a working artificial receptor can be employed to bind or detect undesirable pathogens or toxins in the blood.

Plasma proteins that can be detected employing one or more of the present artificial receptors include, independently, hemoglobin, albumin, IgG total, transferrin, fibrinogen IgA total, alpha-2-macroglobulin, IgM total, alpha-1-antitrypsin, C3 complement, haptoglobin, apolipoprotein A-1, apolipoprotein B, alpha-1-acid glycoprotein, lipoprotein(a), factor H, ceruloplasmin, C4 complement, complement factor B, Prealbumin, C9 Complement, Clq Complement, C8 Complement, C5 Complement, Plasminogen, IgD, Cl Inhibitor, C6 Complement, C7 Complement, Complement Factor I, retinol binding protein, IC3b, Thyroxin Binding globulin, C2 Complement Protein, Thrombus Precursor Protein, C-reactive Protein, C3a Complement Protein, Ferritin, Rantes, SC5b-9 Complex, Myoglobii, thyroglobulin, TPA, C5a Complement, Neuron-Specific Enolase, C-Peptide, Alpha-fetoprotein, TNF Binding Proteins, Prostate Specific Antigen, Prostatic Acid Phosphatase, CEA, Myelin Basic Protein, Troponin I, Interleukin Ira, MIP-1 beta, Troponin T, IL8, MIP-1 alpha, Tissue factor, GSCF, INF-alpha, IL-2, IL-4, TNF alpha, INF gamma, IL-1 beta, IL-12, IL-5, IL-10, and IL-6.

In an embodiment, the present method can include employing one or more working artificial receptors to bind one or more biomarkers. Such a method can employ a plurality of working artificial receptors that can bind a plurality of different biomarkers. The working artificial receptors can be preselected for binding one or more biomarkers or can be naïve to one or more of the biomarkers. The method can include contacting the one or more working artificial receptors with a sample including one or more biomarkers. The identity or pattern of working artificial receptors that bind the one or more biomarkers can identify one or more biomarkers, can produce a “fingerprint” or profile indicative of a disease or disorder, can identify the sample as from an organism or cell affected by a disease or disorder, can identify the sample as from an organism or cell, or the like.

In an embodiment, the present method can include employing one or more working artificial receptors to bind one or more antibodies from serum. Such a method can employ a plurality of working artificial receptors that can bind a plurality of different serum antibodies. The working artificial receptors can be preselected for binding one or more antibodies or can be naïve to one or more of the antibodies. The method can include contacting the one or more working artificial receptors with a sample including one or more antibodies. The identity or pattern of working artificial receptors that bind the one or more antibodies can identify one or more antibodies, can produce a “fingerprint” indicative of a disease or disorder, can identify the sample as from an organism or cell affected by a disease or disorder, can identify the sample as from an organism or cell, or the like.

In an embodiment, the present method can include contacting a working artificial receptor or array with a sample from cells or tissues suspected of being cancerous or including a tumor. The sample can be serum. Binding of at least one biomarker (e.g., protein) to the working artificial receptor or array can indicate or characterize the presence of the particular cancer or tumor, such as by characterizing the pattern of biomarkers (e.g., proteins) present. The biomarker protein can be or include one or more antibodies.

In an embodiment, the present method can include contacting a working artificial receptor or array with a sample from cells or tissues suspected of being from an organism with a particular disease or disorder. The sample can be serum. Binding of at least one biomarker (e.g., protein) to the working artificial receptor or array can indicate or characterize the presence of the particular disease or disorder, such as by characterizing the pattern of biomarkers (e.g., proteins) present. The biomarker protein can be or include one or more antibodies.

In an embodiment, the present method can include employing mass spectrometry to analyze the test ligand or ligands bound to a working artificial receptor or array. For example, the test ligand can be removed from the receptor or array with a laser, which can displace the test ligand (intact or broken into parts) into a mass spectrometer.

In an embodiment, the present method can include employing an affinity surface that can bind a particular test ligand for removing that test ligand from a sample, e.g., a fluid sample or a biological sample, such as a cell culture broth or supernatant. For example, a receptor surface according to the present invention can be employed for binding abundant or common protein (e.g., albumin or IgG) from serum or a cell culture broth or supernatant. The serum or cell culture broth or supernatant lacking the abundant or common protein (e.g., albumin or IgG) can then be more readily analyzed for other proteins, or employed for purposes that benefit from the lack of the protein.

In an embodiment, the present method includes a method for binding or detecting cytochrome (e.g., a cytochrome P450) activity. Such a method can include employing one or more working artificial receptors to bind one or more cytochromes (e.g., a cytochrome P450). Such a method can employ a plurality of working artificial receptors that can bind a plurality of cytochromes (e.g., a cytochrome P450). The working artificial receptors can be preselected for binding one or more cytochromes (e.g., a cytochrome P450) or can be naïve to one or more of the cytochromes (e.g., a cytochrome P450). The method can include contacting the one or more working artificial receptors with a sample including one or more cytochromes (e.g., a cytochrome P450). The identity or pattern of working artificial receptors that bind the one or more cytochromes (e.g., a cytochrome P450) can identify or characterize one or more cytochromes (e.g., a cytochrome P450), can produce a “fingerprint” or activity profile indicative of a disease or disorder, can identify the sample as from an organism or cell affected by a disease or disorder, can identify the sample as from an organism or cell, or the like.

In an embodiment, the present method includes a method for detecting or characterizing cytochrome (e.g., a cytochrome P450) activity. Such a method can include employing one or more working artificial receptors that are a substrate for one or more cytochromes (e.g., a cytochrome P450). Such a method can employ a plurality of working artificial receptors that are a substrate for a plurality of cytochromes (e.g., a cytochrome P450). The working artificial receptors can be preselected for being a substrate for one or more cytochromes (e.g., a cytochrome P450) or can be naïve to one or more of the cytochromes (e.g., a cytochrome P450). The method can include contacting the one or more working artificial receptors with a sample including one or more cytochromes (e.g., a cytochrome P450). The identity or pattern of working artificial receptors that are a substrate for the one or more cytochromes (e.g., a cytochrome P450) can identify or characterize one or more cytochromes (e.g., a cytochrome P450), can produce a “fingerprint” or activity profile indicative of a disease or disorder, can identify the sample as from an organism or cell affected by a disease or disorder, can identify the sample as from an organism or cell, or the like.

In an embodiment, the working artificial receptor for binding or detecting a cytochrome (e.g., a cytochrome P450) includes only building blocks lacking hydroxyl moiety. The building blocks can include one or more building blocks including alkyl or aryl moieties. The alkyl or aryl moieties can be preselected to be substrates for one or more cytochromes. That is, the moiety can be hydroxylated by a cytochrome (e.g., a cytochrome P450). The hydroxylated building block can be detected or labeled, for example, through reaction with a fluorophore. Suitable fluorophores include those with one or more leaving groups that can be displaced by a hydroxyl moiety while maintaining fluorescence.

In an embodiment, the present method includes a method for binding or detecting one or more kinases. Such a method can include employing one or more working artificial receptors to bind one or more kinases. Such a method can employ a plurality of working artificial receptors that can bind a plurality of kinases. The working artificial receptors can be preselected for binding one or more kinases or can be naïve to one or more of the kinases. The method can include contacting the one or more working artificial receptors with a sample including one or more kinases. The identity or pattern of working artificial receptors that bind the one or more kinases can identify one or more kinases, can produce a “fingerprint” indicative of a disease or disorder, can identify the sample as from an organism or cell affected by a disease or disorder, can identify the sample as from an organism or cell, or the like.

In an embodiment, the present method includes a method for detecting or characterizing one or more kinases. Such a method can include employing one or more working artificial receptors to are a substrate for one or more kinases. Such a method can employ a plurality of working artificial receptors that are a substrate for a plurality of kinases. The working artificial receptors can be preselected for being a substrate for one or more kinases or can be naïve to one or more of the kinases. The method can include contacting the one or more working artificial receptors with a sample including one or more kinases. The identity or pattern of working artificial receptors that are a substrate for the one or more kinases can identify one or more kinases, can produce a “fingerprint” or activity profile indicative of a disease or disorder, can identify the sample as from an organism or cell affected by a disease or disorder, can identify the sample as from an organism or cell, or the like.

In an embodiment, the working artificial receptor for binding or detecting a kinase includes one or more building blocks including a hydroxyl. The building blocks can include one or more building blocks including an alcohol or phenol moiety. The building blocks can include one or more moieties that are or that resemble serine, threonine, or tyrosine residues. The hydroxyl-containing moieties can be preselected to be substrates for one or more kinases. That is, the hydroxyl-containing moieties can be phosphorylated by a kinase. The phosphorylated building block can be detected or labeled, for example, through reaction with a fluorophore. Such fluorophores are commercially available.

In an embodiment, the present receptor can be employed to form a molecular logic gate. Such a receptor can include a first building block and a second building block. Functionally coupling the first building block to the second building block, such as through an electrostatic interaction, can produce a signal. In the absence of coupling there is no signal. In the presence of coupling there is a signal. Such a binary signal can be employed to produce a logic gate. Alternatively, the signal can be employed to signal the presence of the moiety that produces functional coupling of the building blocks. In an embodiment, the signal can be absorption or emission of light. In an embodiment, the signal can be fluorescence or quenching fluorescence.

In an embodiment, the present building blocks or artificial receptors can be employed as a molecular seal or certificate. Such a seal or certificate can assure the authenticity of an object including the seal or certificate. For example, the seal or certificate can be made up of two or more regions on a surface or in a material including a single building block coupled to the surface or material. The seal or certificate can also include one region including each of the building blocks in each of the two or more regions. That is, two or more regions including single building block and one or more regions include combinations of the building blocks. Authenticity of the object including the molecular seal or certificate can be evaluated by probing the regions for the presence of each of the individual building blocks and for the combination of building blocks. Probing can include spectral probing for, for example, absorption or fluorescent at any of a variety of wavelengths. In an embodiment, a region including a combination of building blocks can be evaluated as the sum of the signal from probing each of the individual building blocks.

For example, a first spot can include building block 1, a second spot can include building block 2, a third spot can include building block 3, a fourth spot can include building block 4, and a fifth spot can include each of building blocks 1, 2, 3, and 4. For example an absorption, reflectance, or fluorescence signal from the fifth spot can be a sum or combination of the signals from each of the other four spots.

Sensors Employing the Present Artificial Receptors

An embodiment of a sensor system includes a waveguide, a detection system that can be operatively coupled to the waveguide, and a working artificial receptor. The waveguide can be operatively configured with respect to the working artificial receptor such that the waveguide is capable of receiving light that from the vicinity of the working artificial receptor. The detection system can be configured to detect light from the waveguide.

An embodiment of an electrochemical sensing system includes a working electrode, a reference electrode, and a working artificial receptor that is coupled to the working electrode. The sensing system can be configured to generate a sensing signal.

An embodiment of an electrochemical sensing system includes a field effect transistor, and a working artificial receptor that is coupled to the field effect transistor. A signal can be generated by the field effect transistor when a test ligand binds to a working artificial receptor.

An embodiment of sensor system includes a detector and a working artificial receptor that is coupled to the detector. The detector system can be configured to detect the presence of a test ligand bound to the working artificial receptor.

U.S. patent application Ser. No. 10/934,193, filed Sep. 3, 2004, discloses a variety of sensors employing the present artificial receptors or building blocks. This application is incorporated herein in its entirety.

### Embodiments of Sensors Employing the Present Artificial Receptors

In an embodiment, the present artificial receptors can be employed in sensors. The sensors can include active and passive sensors. A passive sensor can, for example, include a working artificial receptor or receptor surface on a substrate including a colored portion. The colored portion of the substrate can be visible through the working artificial receptor or receptor surface. The sensor can include a blocking layer coupled to the working artificial receptor and obscuring the view of the colored portion of the substrate. The sensor is configured so that binding of a predetermined ligand to the working artificial receptor or receptor surface displaces the blocking layer. This displacement reveals the colored portion of the substrate so that a viewer can view it. Appearance of the colored portion of the substrate indicates the presence of the predetermined ligand. Of course, the colored portion of the substrate could be any sort of visible indicator.

Gradients of and Supports for Artificial Receptors and Building Blocks

The present invention includes artificial receptors, building blocks, or combinations of building blocks configured as a gradient on a support. The gradient can be made up of change in the concentration (e.g., density) of an artificial receptor or building block. The gradient can be made up of change in the identity (e.g., structure) of an artificial receptor or building block. The gradient can be made up of change in the topography (e.g., size, shape, or flexibility) of an artificial receptors or building blocks. The gradient can be made up of change in the mode of binding (e.g., irreversible or reversible) of an artificial receptor or building block to the support. The gradient can be described by any of a variety of molecular descriptors for an artificial receptors or building blocks. The gradient can be made up of changes in the lawn or lawn modifier. The gradient can be any of a variety of types of gradients, such as step, continuous, or the like.

One or more of building blocks according to the present invention can be immobilized on a support in regions. These regions can include one or more of the building blocks at different concentrations in different sub-regions. For example, one or more of the building blocks can be in different concentrations in bands on or across the region. For example, one or more of the building blocks can be in a gradient from zero or low concentration at one side (e.g., edge or corner) of the region to higher concentration at the opposite side (e.g., edge or corner) of the region. These regions can include distinct building blocks or combinations of building blocks in different sub-regions. For example, one or more of the building blocks can be in one sub-region but not another. For example, one or more of the building blocks can be at a first concentration in one sub-region and at a another (e.g., second) concentration in another sub-region. For example, one or more building blocks can be in each sub-region. For example, one or more building blocks can be in only a subset of sub-regions.

U.S. patent application Ser. No. 11/004,593, filed Dec. 2, 2004, discloses a variety of gradients of artificial receptor or building blocks and methods of making and using them. This application is incorporated herein. Current proteomics studies rely heavily on gel based chromatography supports which have at least two deficiencies: the gels are fragile, unreliable, etc. and only very simple properties like protein size and pI can be used to separate complex mixtures.

### Embodiments of Gradients of and Supports for Artificial Receptors and Building Blocks

Suitable supports for artificial receptors or a plurality of building blocks or for gradients of artificial receptors or a plurality of building blocks can include a two part support, such as a glass or polymer backing with a layer on its surface. The layer or film can be a polymer, a second polymer, a gel (e.g., silica gel), fiber (e.g., cellulose, microfiber, nanofiber, or the like), or the like.

In an embodiment, the support can include a square sheet or plate of polymer/film which has CARA building blocks covalently bound to the polymer matrix. The polymer/film can include fibers on its surface. In use, the plate can be developed first in one direction along an edge lane followed by development along the second direction to give a 2D pattern of analytes, e.g., proteins. In an embodiment, the support includes:
1) a rectangular or square (e.g., 20×20 cm) sheet that is dimensionally stable upon or after development;
2) the support (e.g., the sheet or a layer such as a fiber layer on the sheet) can, for example, swell and/or wick the developing fluid(s). The developing fluid(s) can be, for example, buffers which may contain detergents, solvents, etc.;
3) in an embodiment, the support will be made from a material such that it can be cut-up or sectioned after developing;
4) in an embodiment, the support will be made from a material that is several mm thick in its swelled or wet state.

In an embodiment, the current support can be employed for protein chromatography and can separate protein (e.g., proteome) mixtures on the basis of interactions with artificial receptors and/or building blocks, which can be in gradients. Although not limiting to the present invention, it is believed that such receptors or building blocks can provide selective molecular recognition driven interactions.

In an embodiment, the present support includes, e.g., a 20×20 cm glass or plastic support plate with a surface including artificial receptors or building blocks and that is configured “wick” the buffers used for chromatography development (e.g., e.g. across the support). In an embodiment, the substrate includes a surface layer of nanofiber. The nanofiber can include bound artificial receptors or building blocks. In an embodiment, the nanofiber with bound artificial receptors or building blocks is in the form of a mat or sheet.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the phrase “adapted and configured” describes a system, apparatus, or other structure that is constructed or configured to perform a particular task or adopt a particular configuration to. The phrase “adapted and configured” can be used interchangeably with other similar phrases such as arranged and configured, constructed and arranged, adapted, constructed, manufactured and arranged, and the like.

All publications and patent applications in this specification are indicative of the level of ordinary skill in the art to which this invention pertains.

The invention has been described with reference to various specific and preferred embodiments and techniques. However, it should be understood that many variations and modifications may be made while remaining within the spirit and scope of the invention.

What is claimed is:

1. A method of making an artificial receptor, the method comprising:
forming a region on a support, the region comprising a plurality of building blocks;
coupling the plurality of building blocks to the support in the region.

2. The method of claim 1, wherein one or more of the building blocks independently comprise:
one or more carboxyl, amine, hydroxyl, phenol, carbonyl, or thiol groups; or
one or more moieties with positive charge, negative charge, acid, base, electron acceptor, electron donor, hydrogen bond donor, hydrogen bond acceptor, free electron pair, π electrons, charge polarization, hydrophilicity, or lipophilic moiety.

3. An artificial receptor, the artificial receptor comprising a plurality of building blocks coupled to a support.

4. The artificial receptor of claim 3, wherein one or more of the building blocks independently comprise:
one or more carboxyl, amine, hydroxyl, phenol, carbonyl, or thiol groups; or
one or more moieties with positive charge, negative charge, acid, base, electron acceptor, electron donor, hydrogen bond donor, hydrogen bond acceptor, free electron pair, Or electrons, charge polarization, hydrophilicity, or lipophilic moiety.

5. A method of detecting a test ligand comprising:
contacting at least one working artificial receptor with a sample suspected of containing the test ligand;
the working artificial receptor comprising a plurality of building blocks coupled to a region of a support; the at least one working artificial receptor being known to bind the test ligand; and
monitoring for binding to the at least one working artificial receptor; binding to the at least one working artificial receptor indicating the presence of the test ligand in the sample.

6. A method of detecting a compound that disrupts an interaction of a test ligand, the method comprising:
contacting at least one working artificial receptor with a test ligand and a candidate disrupter;
the working artificial receptor-comprising a plurality of building blocks coupled to a region of a support; the at least one working artificial receptor being known to bind the test ligand; and
monitoring for those candidate disruptors that decrease binding of the test ligand to the at least one working artificial receptor; decreased binding indicating that the candidate disrupter is a lead disrupter.

7. A method of making a reaction support for a reactant, the method comprising:
contacting at least one candidate artificial receptor with the reactant;
the candidate artificial receptor comprising a plurality of building blocks coupled to a region of a first support;
detecting binding of the test ligand to at least one candidate artificial receptor; and
selecting at least one candidate artificial receptor for which test ligand binding was detected as a working artificial receptor for the test ligand;
contacting at least one working artificial receptor with the reactant and monitoring for a reaction of the reactant;
selecting a working artificial receptor for which the reaction was observed as a reaction artificial receptor; and
coupling the reaction artificial receptor to a second support to form a reaction support.

8. A method of making a surface that does not bind a test ligand, the method comprising:
contacting at least one candidate artificial receptor with the test ligand;
the candidate artificial receptor comprising a plurality of building blocks coupled to a region of a support;
detecting lack of binding of the test ligand to at least one candidate artificial receptor; and
selecting at least one candidate artificial receptor for which test lack of ligand binding was detected as a nonbinding surface for the test ligand.

9. A sensor system comprising:
a waveguide;
a detection system that is operatively coupled to the waveguide;
a working artificial receptor, the waveguide being operatively configured with respect to the working artificial receptor such that the waveguide is capable of receiving light from the working artificial receptor, wherein the detection system is configured to detect the electromagnetic radiation.

10. An electrochemical sensing system comprising:
a working electrode;
a reference electrode; and
a working artificial receptor that is coupled to the working electrode, wherein the sensing system is configured to generate a sensing signal.

11. An electrochemical sensing system comprising:
a field effect transistor;
a working artificial receptor that is coupled to the field effect transistor, wherein a signal can be generated when a test ligand binds to a working artificial receptor.

12. A sensor system comprising:
a detector;
a working artificial receptor that is coupled to the detector, wherein the detector system is configured to detect the presence of a test ligand bound to the working artificial receptor.

13. A building block gradient comprising:
a support; and
a portion of the support comprising at least one building block;
the building block being coupled to the support;
the building block forming a gradient.

14. A method of using building block gradient comprising:
contacting the building block gradient with a test ligand;
the building block gradient comprising:
a support; and
a portion of the support comprising at least one building block;
the building block being coupled to the support;
the building block forming a gradient;
monitoring the gradient for binding of the test ligand.
